(19) United States
(12) Patent Application Publication
(10) Pub. No.: US 2017/0158960 A1
(43) Pub. Date: Jun. 8, 2017

(54) NEMATIC LIQUID CRYSTAL COMPOSITION AND LIQUID CRYSTAL DISPLAY DEVICE INCLUDING THE SAME

(71) Applicant: DIC CORPORATION, Tokyo (JP)

(72) Inventors: Go Sudo, Kita-adachi-gun (JP); Shinichi Hirata, Kita-adachi-gun (JP)

(73) Assignee: DIC Corporation, Tokyo (JP)

(21) Appl. No.: 15/321,540

(22) PCT Filed: Jul. 2, 2015
(86) PCT No.: PCT/JP2015/069111

§ 371 Date: Dec. 22, 2016

(30) Foreign Application Priority Data
Jul. 8, 2014 (JP) 2014-140508

(51) Int. Cl. C09K 19/34; C09K 19/54

(52) U.S. Cl. CPC C09K 19/3444; C09K 19/542; C09K 2019/548

(57) ABSTRACT

Provided are a liquid crystal composition containing a compound represented by general formula (I-IV):

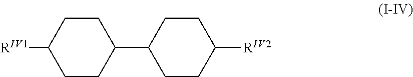

and a compound represented by general formula (I):

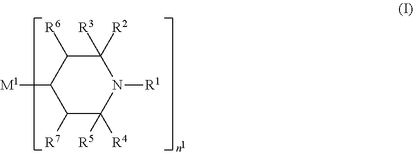

and a liquid crystal display device including the liquid crystal composition. The liquid crystal composition according to the present invention has a sufficiently low viscosity (η), a sufficiently low rotational viscosity (γ1), a high elastic constant (K₃₃), a high voltage holding ratio after UV exposure (VHR(UV)), and a large absolute value of negative dielectric anisotropy (Δ∈) without decreased refractive index anisotropy (Δn) or nematic-isotropic liquid phase transition temperature (Tₙᵢ). The display device including the liquid crystal composition has fast response time and good display quality with reduced or no display defects.

### TECHNICAL FIELD

The present invention relates to nematic liquid crystal compositions of negative dielectric anisotropy (Δ∈), which are useful as liquid crystal display materials, and to liquid crystal display devices including such liquid crystal compositions.

### BACKGROUND ART

Liquid crystal display devices are used in products such as clocks, calculators, household electrical appliances, measuring instruments, automotive instrument panels, word processors, electronic organizers, printers, computers, and televisions. Typical liquid crystal display modes include twisted nematic (TN), super-twisted nematic (STN), dynamic scattering (DS), guest-host (GH), in-plane switching (IPS), optically compensated birefringence (OCB), electrically controlled birefringence (ECB), vertical alignment (VA), color super-homeotropic (CSH), and ferroelectric liquid crystal (FLC). Driving modes include static driving, multiplex driving, simple-matrix driving, and active-matrix (AM) driving using elements such as thin-film transistors (TFTs) and thin-film diodes (TFDs).

Some of these display modes, including IPS, ECB, VA, and CSH, are distinguished by the use of liquid crystal materials of negative Δ∈. In particular, the VA display mode, which employs AM driving, is used in display devices requiring high speed and wide viewing angle, such as those for television applications.

Nematic liquid crystal compositions for display modes such as VA require low-voltage driving, fast response time, and a wide operating temperature range. Specifically, these liquid crystal compositions require a large absolute value of negative Δ∈, low viscosity, and a high nematic-isotropic liquid phase transition temperature (Tₙᵢ). It is also necessary to adjust the refractive index anisotropy (Δn) of the liquid crystal materials to match the cell gap (d) based on the product of Δn and d, i.e., Δn× d. In addition, liquid crystal display devices for applications such as televisions require liquid crystal materials with low viscosity (η) since fast response time is desired.

Research has been conducted on various compounds with large absolute values of negative Δ∈ to provide liquid crystal compositions with improved properties.

One disclosed liquid crystal material of negative Δ∈ is a liquid crystal composition containing liquid crystal compounds of formulas (A) and (B) below, which have a 2,3-difluorophenylene backbone (see PTL 1).

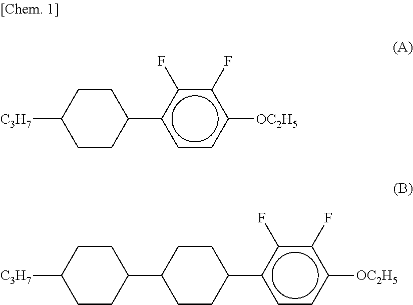

This liquid crystal composition further contains liquid crystal compounds of formulas (C) and (D), which have a Δ∈ of substantially zero. Unfortunately, this liquid crystal composition does not have a sufficiently low viscosity for applications requiring fast response time, including liquid crystal display televisions.

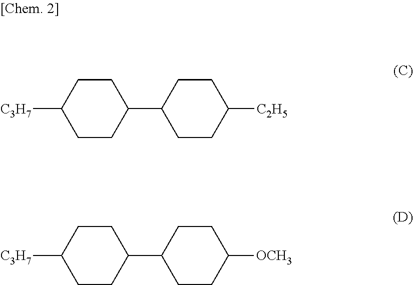

Also disclosed are liquid crystal compositions containing a compound represented by formula (E). One liquid crystal composition further contains the liquid crystal compound of formula (D) and has a low Δn (see PTL 2). Another liquid crystal composition further contains a compound having an alkenyl group in the molecule thereof (i.e., an alkenyl compound), such as a liquid crystal compound of formula (F), for improved response time (see PTL 3). Unfortunately, these liquid crystal compositions require further research to achieve both a high Δn and high reliability.

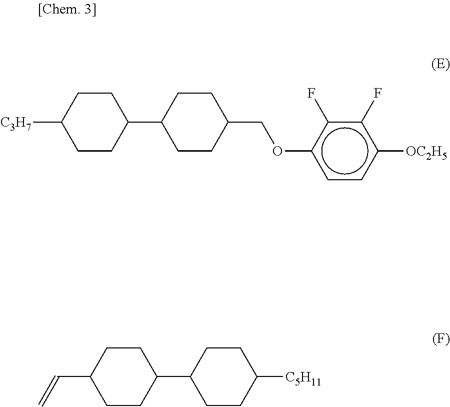

Also disclosed is a liquid crystal composition containing a compound represented by formula (G) (see PTL 4). Unfortunately, this liquid crystal composition further contains an alkenyl compound such as the liquid crystal compound of formula (F) and thus tends to cause display defects such as image-sticking and uneven display.

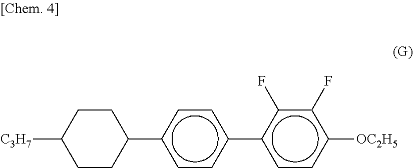

The influence of liquid crystal compositions containing alkenyl compounds on display defects has been disclosed (see PTL 5). Generally, a liquid crystal composition containing a smaller amount of alkenyl compound has a higher η and thus makes it more difficult to achieve fast response time; therefore, it is difficult to achieve both reduced display defects and fast response time.

Thus, it is difficult to develop a liquid crystal composition of negative Δ∈ that has both a high Δn and a low η and that causes reduced or no display defects simply by the use of a compound of negative Δ∈ in combination with the liquid crystal compound of formula (C), (D), or (F).

It is generally believed that high voltage holding ratios (VHRs) are essential for providing a liquid crystal composition and liquid crystal display device with little or no likelihood of display defects such as image-sticking and uneven display. For example, PTLs 7, 8, and 9 disclose the use of a liquid crystal composition containing a particular compound in combination with an antioxidant, UV absorber, or light stabilizer to achieve a higher VHR.

PTL 6 discloses the use of a liquid crystal material having a high factor expressed by equation 1 to provide a homeotropic liquid crystal cell with improved response time. Unfortunately, this technique is insufficient.

[Math. 1]

FoM=K₃₃Δn²/γ1 (equation 1)
K₃₃: elastic constant
Δn: refractive index anisotropy
γ1: rotational viscosity

Accordingly, there is a need for a liquid crystal composition having a sufficiently low viscosity (η), a sufficiently low rotational viscosity (γ₁), a high elastic constant (K₃₃), and a high voltage holding ratio (VHR) without decreased refractive index anisotropy (Δn) or nematic-isotropic liquid phase transition temperature (Tₙᵢ) in applications requiring fast response time, including liquid crystal display televisions. There is also a need for a liquid crystal display device including such a liquid crystal composition and having fast response time and good display quality with reduced or no display defects such as image-sticking and uneven display.

### CITATION LIST

### Patent Literature

PTL 1: Japanese Unexamined Patent Application Publication No. 8-104869

PTL 2: European Patent Application Publication No. 0474062

PTL 3: Japanese Unexamined Patent Application Publication No. 2006-37054

PTL 4: Japanese Unexamined Patent Application Publication No. 2001-354967

PTL 5: Japanese Unexamined Patent Application Publication No. 2008-144135

PTL 6: Japanese Unexamined Patent Application Publication No. 2006-301643

PTL 7: Japanese Unexamined Patent Application Publication No. 2002-256267

PTL 8: Japanese Unexamined Patent Application Publication (Translation of PCT Application) No. 2014-505745

PTL 9: Japanese Unexamined Patent Application Publication (Translation of PCT Application) No. 2014-505746

### SUMMARY OF INVENTION

### Technical Problem

An object of the present invention is to provide a liquid crystal composition having a sufficiently low viscosity (η), a sufficiently low rotational viscosity (γ1), a high elastic constant (K₃₃), a high voltage holding ratio after UV exposure (VHR(UV)), and a large absolute value of negative dielectric anisotropy (Δ∈) without decreased refractive index anisotropy (Δn) or nematic-isotropic liquid phase transition temperature (Tₙᵢ), and to provide a liquid crystal display device, such as a VA, PSVA, PSA, FFS, IPS, or ECB display device, including such a liquid crystal composition and having fast response time and good display quality with reduced or no display defects.

### Solution to Problem

The inventors have found that the foregoing object can be achieved by the use of a composition containing a compound represented by general formula (I-IV), where it is desirable to achieve both reduced display defects and fast response time, in combination with a particular compound, which has led to the present invention.

Specifically, the present invention provides a liquid crystal composition containing one or more compounds selected from the group consisting of compounds represented by general formula (I-IV) and one or more compounds represented by general formula (I) and also provides a liquid crystal display device including the liquid crystal composition.

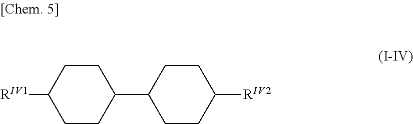

(In the formula, R^{IV1} and R^{IV2} are each independently an alkyl group of 1 to 10 carbon atoms, an alkoxyl group of 1 to 10 carbon atoms, an alkenyl group of 2 to 10 carbon atoms, or an alkenyloxy group of 2 to 10 carbon atoms, where one or more non-adjacent —CH₂— groups present in the groups are each independently optionally replaced with —O— or —S—, and one or more hydrogen atoms present in the groups are each independently optionally replaced with a fluorine or chlorine atom.)

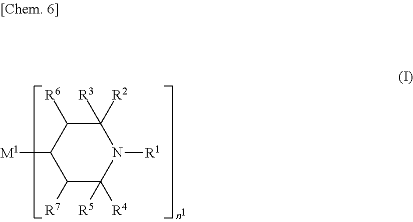

(In the formula, R¹ is a hydrogen atom, —O—, —OH, or an alkyl group of 1 to 12 carbon atoms, where one or more —CH₂— groups present in the alkyl group are each independently optionally replaced with —O—, —S—, —CH═CH—, —C≡C—, —CO—, —CO—O—, —O—CO—, —OCF₂—, or —CF₂O—; R², R³, R⁴, and R⁵ are each independently an alkyl group of 1 to 8 carbon atoms, where one or more —CH₂— groups present in the alkyl group are each independently optionally replaced with —O—, —S—, —CH═CH—, —C≡C—, —CO—, —CO—O—, —O—CO—, —OCF₂—, or —CF₂O—, and R² and R³ and/or R⁴ and R⁵ are optionally taken together to form a ring; R⁶ and R⁷ are each independently a hydrogen atom or an alkyl group of 1 to 6 carbon atoms, where one or more —CH₂— groups present in the alkyl group are each independently optionally replaced with —O—, —S—, —CH═CH—, —C≡C—, —CO—, —CO—O—, —O—CO—, —OCF₂—, or —CF₂O—; n¹ is an integer of 1 to 6, where if n¹ is an integer of 2 to 6, each occurrence of R¹, R², R³, R⁴, R⁵, R⁶, and R⁷ may be the same or different; and M¹ is a monovalent to hexavalent organic group having a valence equal to n¹.)

### Advantageous Effects of Invention

The liquid crystal composition according to the present invention has a sufficiently low viscosity (η), a sufficiently low rotational viscosity (γ₁), a high elastic constant (K₃₃), a large absolute value of negative dielectric anisotropy (Δ∈), and a high voltage holding ratio (VHR) without decreased refractive index anisotropy (Δn) or nematic-isotropic liquid phase transition temperature (Tₙᵢ). The liquid crystal display device, such as a VA, PSVA, PSA, or FFS display device, including the liquid crystal composition has fast response time and good display quality with reduced or no display defects.

### DESCRIPTION OF EMBODIMENTS

A liquid crystal composition according to the present invention contains one or more compounds represented by general formula (I-IV).

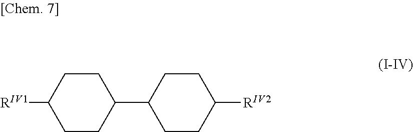

To reduce the viscosity, it is preferred that R^{IV1} and R^{IV2} in general formula (I-IV) be an alkyl group of 1 to 8 carbon atoms or an alkenyl group of 2 to 8 carbon atoms, more preferably an alkyl group of 1 to 5 carbon atoms or an alkenyl group of 2 to 5 carbon atoms, even more preferably an alkyl group of 2 to 4 carbon atoms or an alkenyl group of 2 to 4 carbon atoms. R^{IV1} and R^{IV2} are also preferably linear.

As the compounds represented by general formula (I-IV), the liquid crystal composition according to the present invention preferably contains one or more compounds selected from the group consisting of compounds represented by general formulas (I-V) and (I-V1).

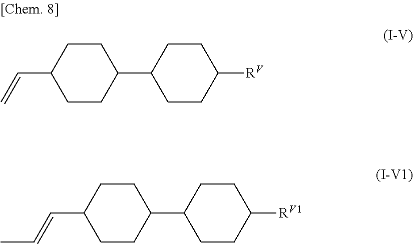

To reduce the viscosity, it is preferred that R^{V} and R^{V1} in general formulas (I-V) and (I-V1) be an alkyl group of 1 to 8 carbon atoms or an alkenyl group of 2 to 8 carbon atoms, more preferably an alkyl group of 1 to 5 carbon atoms or an alkenyl group of 2 to 5 carbon atoms, even more preferably an alkyl group of 2 to 4 carbon atoms or an alkenyl group of 2 to 4 carbon atoms. R^{V} and R^{V1} are also preferably linear. More specifically, R^{V} is preferably an alkenyl group of 2 carbon atoms, and R^{V1} is preferably an alkenyl group of 3 carbon atoms. That is, the left and right side chains of general formulas (I-V) and (I-V1) are preferably identical. To reduce the viscosity, it is preferred that R^{V} or R^{V1} be an alkenyl group.

The liquid crystal composition may contain at least one or more compounds represented by either general formula (I-V) or (I-V1), or may contain both one or more compounds represented by general formula (I-V) and one or more compounds represented by general formula (I-V1). More specifically, to achieve a lower viscosity or lower rotational viscosity, it is preferred that compounds represented by general formula (I-V) be present in larger amounts. To achieve a higher elastic constant, it is preferred that compounds represented by general formula (I-V1) be present in larger amounts. To provide a liquid crystal display device with a faster response time, it is preferred that both be simultaneously present in as large amounts as possible.

Preferred compounds represented by general formula (I-IV) include compounds represented by formulas (I-IV-1) to (I-IV-6) below.

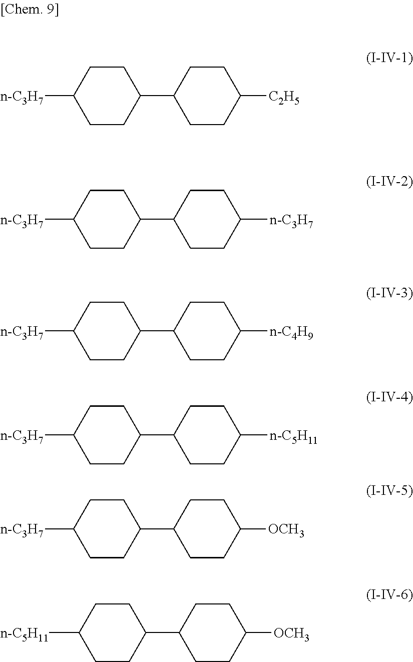

The compounds selected from the group consisting of compounds represented by general formula (I-IV) are preferably present in the liquid crystal composition in an amount of 3% to 70% by mass, more preferably 10% to 70% by mass, even more preferably 20% to 60% by mass, still more preferably 20% to 50% by mass. More specifically, the compounds selected from the group consisting of compounds represented by general formula (I-IV) are preferably present in an amount of 25% to 55% by mass to achieve a lower viscosity or lower rotational viscosity, whereas they are preferably present in an amount of 3% to 40% by mass if reduced precipitation at low temperature is desired.

More specifically, the compounds represented by general formula (I-IV) are preferably present in the composition in an amount, as the lower limit, of 1% by mass (hereinafter the percentages in the composition are by mass) or more, more preferably 2% or more, more preferably 5% or more, more preferably 8% or more, more preferably 10% or more, more preferably 13% or more, more preferably 15% or more, more preferably 18% or more, more preferably 20% or more, more preferably 23% or more, more preferably 25% or more, more preferably 28% or more, more preferably 30% or more, more preferably 33% or more, more preferably 35% or more, more preferably 40% or more, more preferably 45% or more, more preferably 50% or more. The compounds represented by general formula (I-IV) are preferably present in an amount, as the upper limit, of 80% or less, more preferably 70% or less, more preferably 70% or less, more preferably 65% or less, more preferably 60% or less, more preferably 58% or less, more preferably 55% or less, more preferably 53% or less, more preferably 50% or less, more preferably 48% or less, more preferably 45% or less, more preferably 43% or less, more preferably 40% or less, more preferably 38% or less, more preferably 35% or less, more preferably 33% or less, more preferably 30% or less.

The liquid crystal composition according to the present invention contains at least one or more compounds represented by general formula (I).

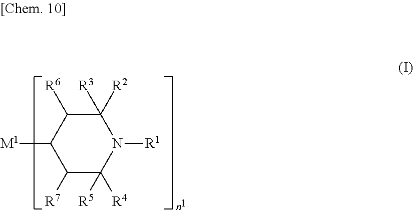

To improve the photodegradation resistance, it is preferred that R¹ in general formula (I) be a hydrogen atom, —O., or —OH, more preferably a hydrogen atom or —OH, even more preferably a hydrogen atom. To improve the compatibility with the liquid crystal composition, it is preferred that R¹ in general formula (I) be an unsubstituted alkyl group of 1 to 12 carbon atoms, an alkoxy group of 1 to 12 carbon atoms, or an alkenyl group of 3 to 12 carbon atoms, more preferably an unsubstituted alkyl group of 1 to 8 carbon atoms, an alkoxy group of 1 to 8 carbon atoms, or an alkenyl group of 3 to 8 carbon atoms, even more preferably an unsubstituted alkyl group of 1 to 4 carbon atoms, an alkoxy group of 1 to 4 carbon atoms, or an alkenyl group of 3 or 4 carbon atoms. R¹ is also preferably linear.

R², R³, R⁴, and R⁵ are preferably each independently an alkyl group of 1 to 4 carbon atoms, are preferably unsubstituted alkyl, and are preferably linear. More preferably, one or more of R², R³, R⁴, and R⁵ are methyl, and even more preferably, all of R², R³, R⁴, and R⁵ are methyl. R² and R³ and/or R⁴ and R⁵ are optionally taken together to form a ring structure.

R⁶ and R⁷ are preferably a hydrogen atom or an alkyl group of 1 to 4 carbon atoms. A hydrogen atom is more preferred for reasons of ease of manufacture.

n¹ is an integer of 1 to 6. M¹ is a monovalent to hexavalent organic group having a valence equal to n¹. Preferably, n¹ is 3, and M¹ is a trivalent organic group.

If n¹ is 3, it is preferred that M¹ be a structure represented by general formula (I-M) to improve the compatibility with the liquid crystal composition and the storage stability.

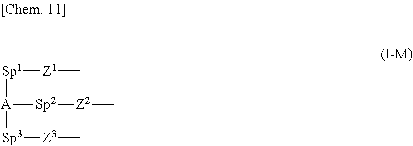

(In the formula, Z¹, Z², and Z³ are each independently —O—, —S—, —CH═CH—, —C≡C—, —CO—, —CO—O—, —O—CO—, —OCF₂—, —CF₂O—, —NH—, or a single bond; Sp¹, Sp², and Sp³ are each independently a single bond or an alkylene group of 1 to 10 carbon atoms, where one or more —CH₂— groups present in the alkylene group are each independently optionally replaced with —O—, —S—, —CH═CH—, —C≡C—, —CO—, —CO—O—, —O—CO—, —OCF₂—, or —CF₂O—; and A is selected from the following groups.)

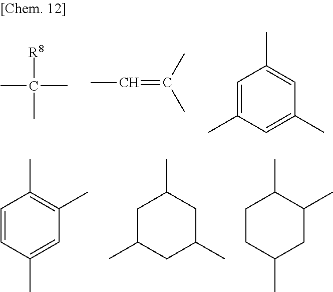

(In the formulas, R⁸ is a hydrogen atom, —OH, or an alkyl group of 1 to 10 carbon atoms, where one or more —CH₂— groups present in the alkyl group are each independently optionally replaced with —O—, —S—, —CH═CH—, —C≡C—, —CO—O—, or —O—CO—, and the hydrogen atoms present in the cyclic structures are optionally replaced with a halogen atom or cyano group.)

For reasons of ease of manufacture and the availability of stock materials, it is preferred that at least one or more of Z¹, Z², and Z³ be —O—, —CO—O—, or a single bond, and it is more preferred that all of Z, Z², and Z³ be —O—, —CO—O—, or a single bond. Sp¹, Sp², and Sp³ are preferably a single bond or an alkylene group of 1 to 10 carbon atoms, more preferably a single bond or an alkylene group of 1 to 8 carbon atoms, even more preferably a single bond or an alkylene group of 1 to 4 carbon atoms. Preferably, the alkylene group is unsubstituted, or one or more —CH₂— groups present in the alkylene group are each independently replaced with —O—, —CO—, —CO—O—, or —O—CO—. More preferably, the alkylene group is unsubstituted. Specifically, Sp¹, Sp², and Sp³ are preferably —CO—, —CH₂—CO—, —CH₂—CH₂—CO—, —CH₂—O—, —CH₂—CH₂—O—, —CH₂—CH₂—CH₂—O—, —CH₂—O—CO—, —CH₂—CH₂—O—CO—, —CH₂—CH₂—CH₂—O—CO—, an unsubstituted alkylene group of 1 to 4 carbon atoms, or a single bond.

-Sp¹-Z¹—, -Sp²-Z²—, and -Sp²-Z²— are preferably each independently —CO—O—, —CH₂—CO—O—, —CH₂—CH₂—CO—O—, —CH₂—CH₂—CH—CO—O—, —CH₂—O—, —CH₂—CH—O—, —CH₂—CH₂—CH—O—, —CH₂—O—CO—O—, —CH₂—CH₂—O—CO—O—, or —CH₂—CH₂—CH₂—O—CO—O—, more preferably —CO—O—, —CH₂—CO—O—, or —CH₂—CH₂—CO—O—.

To improve the compatibility with the liquid crystal composition and the storage stability, it is preferred that A be a structure represented by the following formula.

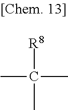

(In the formula, R⁸ is a hydrogen atom, —OH, or an alkyl group of 1 to 10 carbon atoms, where one or more —CH₂— groups present in the alkyl group are each independently optionally replaced with —O—, —S—, —CH═CH—, —C≡C—, —CO—O—, or —O—CO—.) For reasons of ease of manufacture and the availability of stock materials, it is preferred that Re be a hydrogen atom, —OH, an alkyl group of 2 to 10 carbon atoms, or —O—CO—R⁹ (where R⁹ is an alkyl group of 1 to 9 carbon atoms), more preferably a hydrogen atom.

Preferred compounds represented by general formula (I) where n¹ is 3 include compounds represented by general formula (I-a) below.

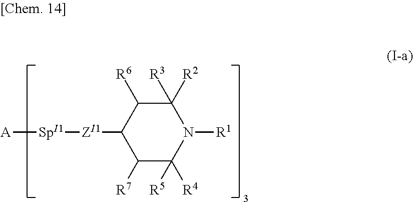

(In the formula, R¹, R², R³, R⁴, R⁵, R⁶, and R⁷ are each independently as defined for R¹, R², R³, R⁴, R⁵, R⁶, and R⁷, respectively, in general formula (I); A is as defined for A in general formula (I-M); Z^{I1} is —O—, —S—, —CO—, —CO—O—, —O—CO—, —NH—, or a single bond; Sp^{I1} is a single bond or an alkylene group of 1 to 10 carbon atoms; and each occurrence of R¹, R², R³, R⁴, R⁵, R⁶, R⁷, Z^{I1}, and Sp^{I1} may be the same or different.) Z^{I1} is preferably —O—, —CO—O—, or a single bond. Sp^{I1} is preferably a single bond or an unsubstituted alkyl group of 1 to 4 carbon atoms and is preferably linear.

Other preferred compounds represented by general formula (I) where n¹ is 3 include compounds represented by general formula (I-a.1).

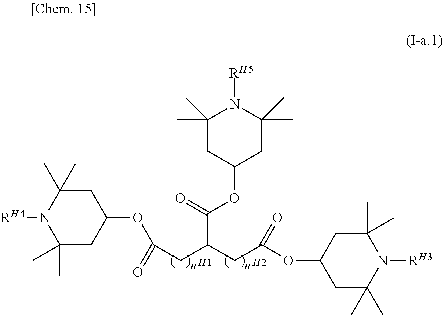

(In the formula, R^{H3}, R^{H4}, and R^{H5} are each independently as defined for R¹ in general formula (I); and n^{H1} and n^{H2} are each independently an integer of 0 to 4.) In general formula (I-a.1), R^{H3}, R^{H4}, and R^{H5} are preferably a hydrogen atom. If R^{H3}, R^{H4}, or R^{H5} is an alkyl group, it preferably has 1 to 8 carbon atoms, more preferably 1 to 5 carbon atoms, even more preferably 1 to 3 carbon atoms, still more preferably 1 carbon atom.

Specific examples of preferred compounds represented by general formula (I) are illustrated below, although they are not intended to limit the present invention.

Particularly preferred compounds represented by general formula (I) where n¹ is 3 include compounds represented by general formulas (I-a1) to (I-a14).

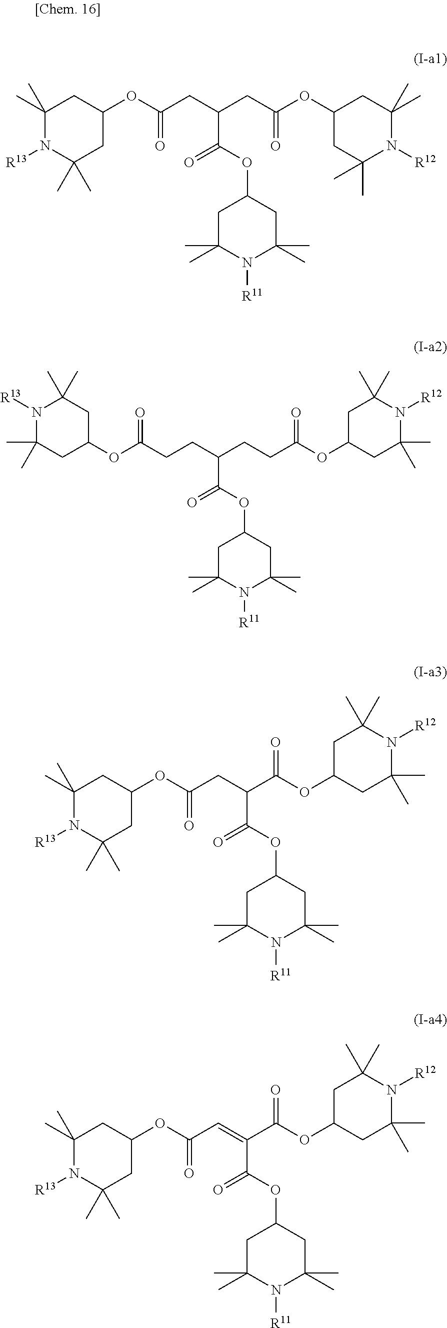

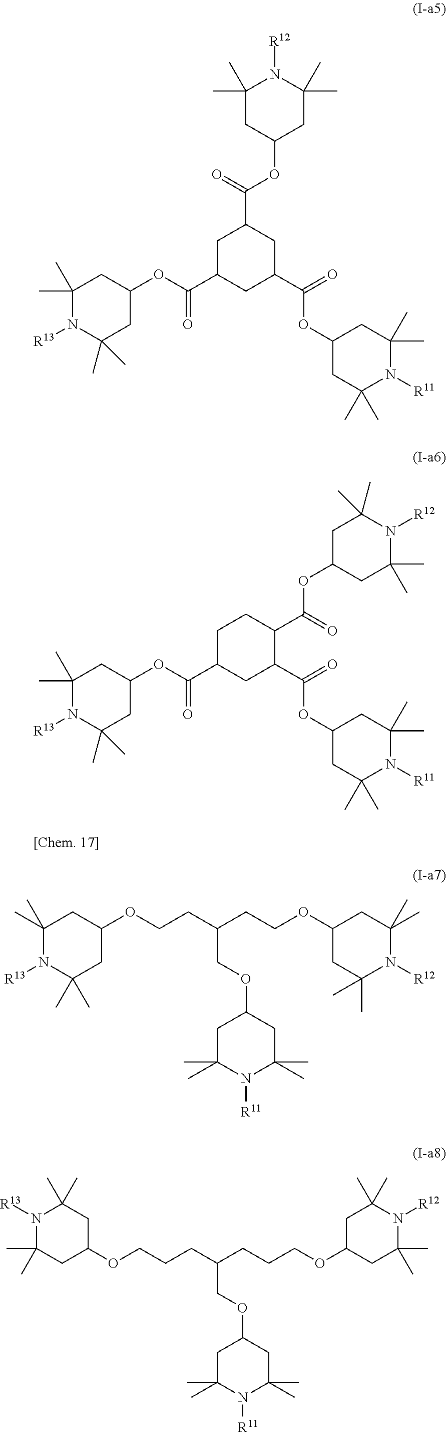

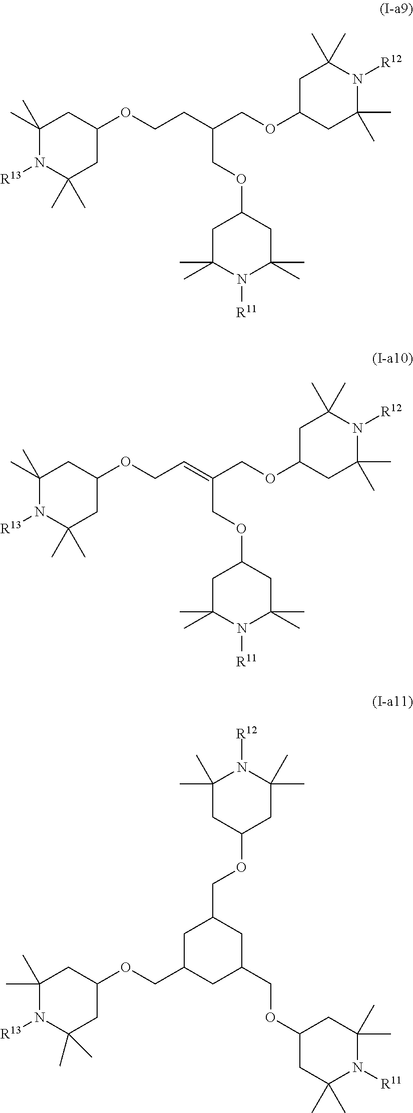

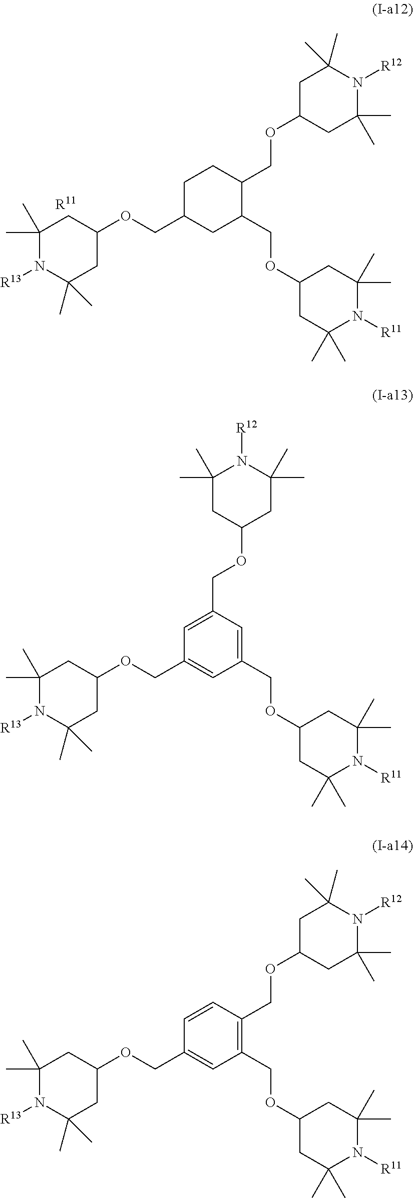

(In the formulas, R¹¹, R¹², and R¹³ are each independently as defined for R¹ in general formula (I).)

More specifically, compounds represented by general formulas (I-a1-1) to (I-a6-1) are preferred.

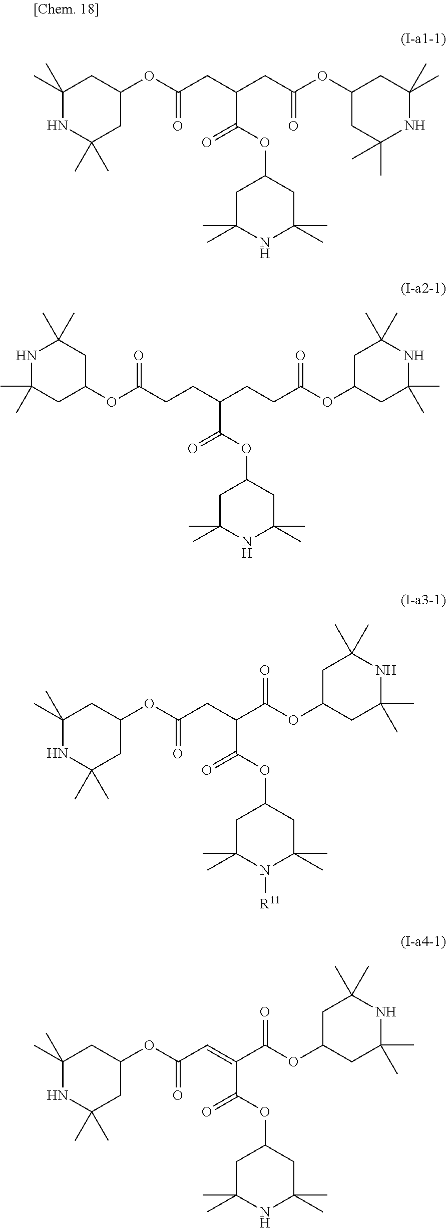

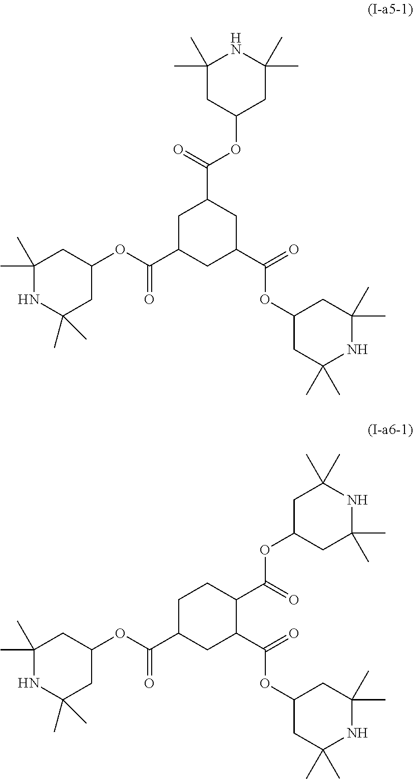

Other preferred compounds represented by general formula (I) include compounds represented by general formula (I-1) below.

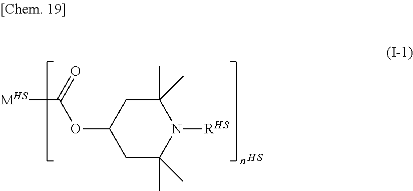

In general formula (I-1), R^{HS} is each independently a hydrogen atom or an alkyl group of 1 to 10 carbon atoms, preferably a hydrogen atom. If R^{HS} is an alkyl group, it preferably has 1 to 8 carbon atoms, more preferably 1 to 5 carbon atoms, even more preferably 1 to 3 carbon atoms, still more preferably 1 carbon atom. Each occurrence of R^{HS} may be the same or different.

If n^{HS} is 1, M^{HS} is an alkyl group of 1 to 15 carbon atoms. If n^{HS} is an integer of 2 to 6, M^{HS} is an alkylene group of 1 to 15 carbon atoms, where one or more —CH₂— groups present in M^{HS} are optionally replaced with —O—, —CH═CH—, —C≡C—, —CO—, —OCO—, —COO—, trans-1,4-cyclohexylene, 1,4-phenylene, or naphthalene-2,6-diyl. For reasons of the viscosity of the liquid crystal composition and the volatility of the compound itself, it is preferred that M^{HS} be an alkyl or alkylene group of 2 to 10 carbon atoms, more preferably an alkyl or alkylene group of 2 to 8 carbon atoms, even more preferably an alkyl or alkylene group of 4 to 8 carbon atoms, still more preferably an alkyl or alkylene group of 6 or 8 carbon atoms. M^{HS} may be linear or branched.

n^{HS} is an integer of 1 to 6, preferably 2 to 4.

Preferred compounds represented by general formula (I-1) where n^{HS} is 1 include compounds represented by general formulas (I-11) and (I-12).

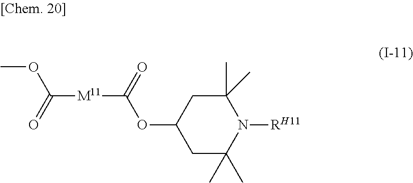

(In the formula, R^{H11} is each independently a hydrogen atom or an alkyl group of 1 to 10 carbon atoms; and M is an alkylene group of 1 to 13 carbon atoms.)

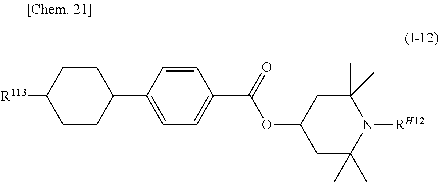

(In the formula, R^{H12} and R^{I13} are each independently a hydrogen atom or an alkyl group of 1 to 10 carbon atoms.)

Preferred compounds represented by general formula (I-1) where n^{HS} is 2 include compounds represented by general formula (I-2).

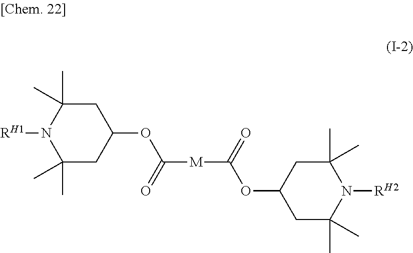

(In the formula, R^{H1} and R^{H2} are each independently a hydrogen atom or an alkyl group of 1 to 10 carbon atoms; and M is an alkylene group of 1 to 15 carbon atoms, where one or more —CH₂— groups present in M is optionally replaced with —O—, —CH═CH—, —C≡C—, —CO—, —OCO—, —COO—, trans-1,4-cyclohexylene, 1,4-phenylene, or naphthalene-2,6-diyl.)

In general formula (I-2), R^{H1} and R^{H2} are preferably a hydrogen atom. If R^{H1} or R^{H2} is an alkyl group, it preferably has 1 to 8 carbon atoms, more preferably 1 to 5 carbon atoms, even more preferably 1 to 3 carbon atoms, still more preferably 1 carbon atom.

In general formula (I-2), M is an alkylene group of 1 to 15 carbon atoms. For reasons of the viscosity of the liquid crystal composition and the volatility of the compound itself, it is preferred that M be an alkyl or alkylene group of 2 to 10 carbon atoms, more preferably an alkylene group of 4 to 8 carbon atoms, even more preferably an alkylene group of 6 or 8 carbon atoms.

Specific examples include compounds represented by general formulas (I-24), (I-26), and (I-28). R^{H1} and R^{H2} in these formulas are as defined above.

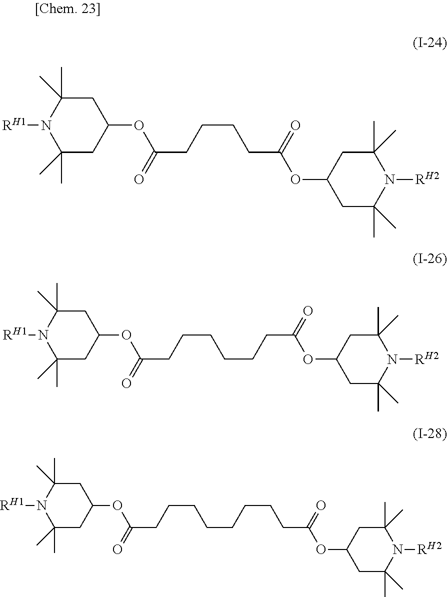

More specific examples include compounds represented by general formulas (I-24H), (I-26H), and (I-28H). Bis(2,2,6,6-tetramethyl-4-piperidyl) sebacate, which is represented by general formula (I-28H), is most suitable.

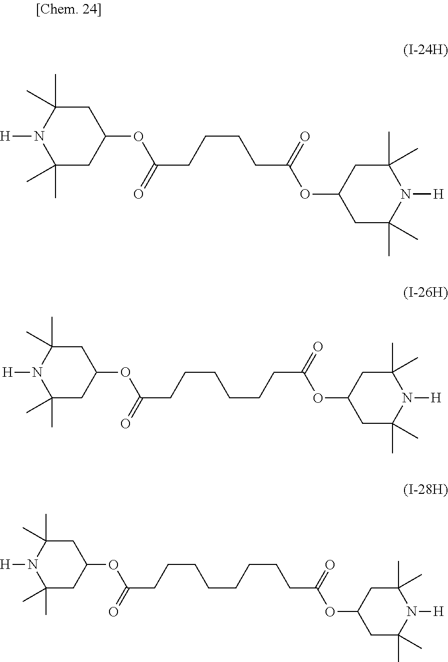

Preferred compounds represented by general formula (I-1) where n^{HS} is an integer of 3 to 6 include compounds represented by general formula (I-3). Compounds represented by general formula (I-3) are more effective because of their high effective amine concentrations. In addition, whereas compounds represented by general formula (I-1) with low molecular weights tend to adsorb onto the alignment layers in liquid crystal display devices and thus often induce uneven display, compounds represented by general formula (I-3) have high molecular weights and thus induce no uneven display.

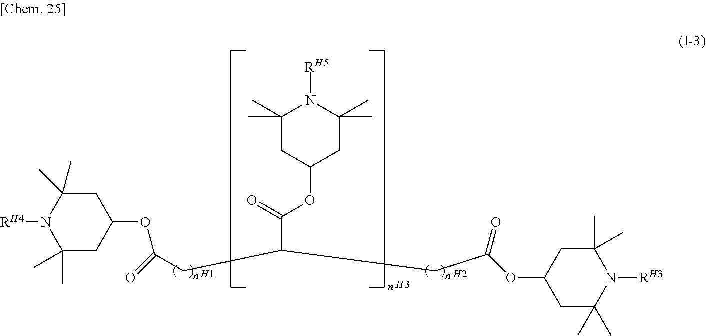

(In the formula, R^{H3}, R^{H4}, and R^{H5} are each independently a hydrogen atom or an alkyl group of 1 to 10 carbon atoms; n^{H1} and n^{H2} are each independently 0 or 1; and n^{H3} is an integer of 1 to 4, where if n^{H3} is 2, 3, or 4, each occurrence of R^{H5} may be the same or different.) In general formula (I-3), R^{H3}, R^{H4}, and R^{H5} are preferably a hydrogen atom. If R^{H3}, R^{H4}, or R^{H5} is an alkyl group, it preferably has 1 to 8 carbon atoms, more preferably 1 to 5 carbon atoms, even more preferably 1 to 3 carbon atoms, still more preferably 1 carbon atom.

In general formula (I-3), n^{H3} is preferably 1. Specific examples include compounds represented by general formulas (I-a1) to (I-a6) above. In general formula (I-3), n^{H3} is also preferably 2. Specific examples include compounds represented by general formulas (I-31) and (I-32). R^{H3}, R^{H4}, and R^{H5} in these formulas are as defined above.

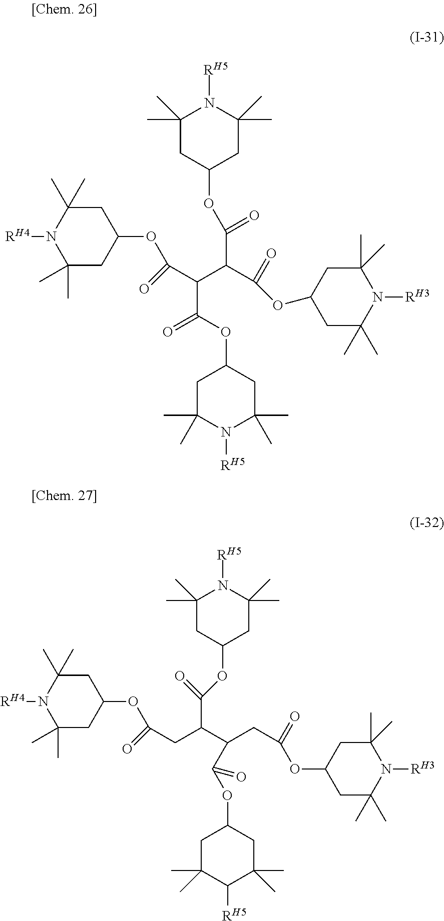

More specifically, a compound represented by general formula (I-32H) is preferred.

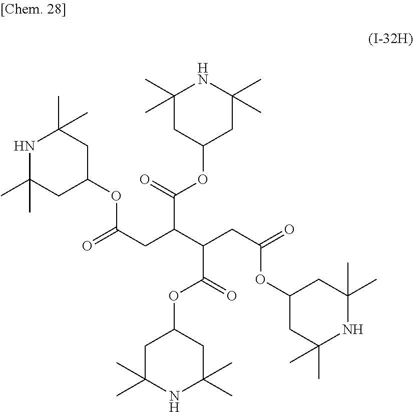

The compounds represented by general formula (I) contain no structure in which heteroatoms are directly linked to each other.

The liquid crystal composition preferably contains two or more compounds represented by general formula (I). Specifically, the liquid crystal composition preferably contains two or more compounds selected from the group consisting of compounds represented by general formulas (I-2), (I-31), (I-32), and (I-a), more preferably a combination of compounds selected from the following combinations: general formulas (I-2) and (I-31), general formulas (I-2) and (I-32), general formulas (I-2) and (I-a), general formulas (I-31) and (I-a), and general formulas (I-32) and (I-a).

The compounds represented by general formula (I) are preferably present in the liquid crystal composition in an amount, as the lower limit, of 0.01% or more, more preferably 0.02% or more, more preferably 0.03% or more, more preferably 0.05% or more, more preferably 0.07% or more, more preferably 0.1% or more, more preferably 0.15% or more, more preferably 0.2% or more, more preferably 0.25% or more, more preferably 0.3% or more, more preferably 0.5% or more, more preferably 1% or more. The compounds represented by general formula (I) are preferably present in an amount, as the upper limit, of 5% or less, more preferably 3% or less, more preferably 1% or less, more preferably 0.5% or less, more preferably 0.45% or less, more preferably 0.4% or less, more preferably 0.35% or less, more preferably 0.3% or less, more preferably 0.25% or less, more preferably 0.2% or less, more preferably 0.15% or less, more preferably 0.1% or less, more preferably 0.07% or less, more preferably 0.05% or less, more preferably 0.03% or less.

More specifically, the compounds represented by general formula (I) are preferably present in an amount of 0.01% to 5% by mass, more preferably 0.01% to 0.3% by mass, even more preferably 0.02% to 0.3% by mass, still more preferably 0.05% to 0.25% by mass. More specifically, the compounds represented by general formula (I) are preferably present in an amount of 0.01% to 0.1% by mass if reduced precipitation at low temperature is desired.

The liquid crystal composition according to the present invention preferably contains one or more of compounds represented by general formulas (LC3) to (LC5).

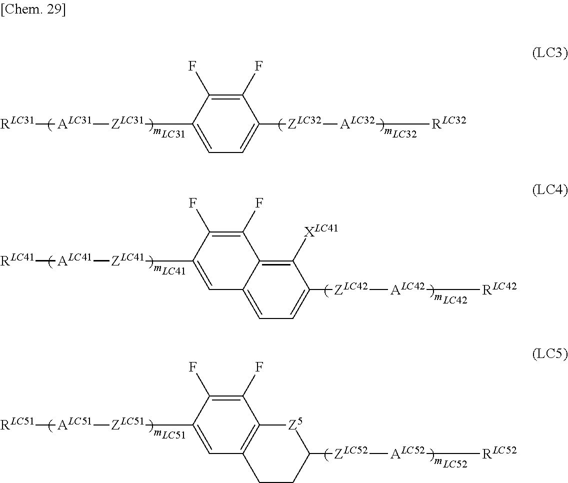

(In the formulas, R^{LC31}, R^{LC32}, R^{LC41}, R^{LC42}, R^{LC51}, and R^{LC52} are each independently an alkyl group of 1 to 15 carbon atoms or an alkenyl group of 2 to 15 carbon atoms, where one or more —CH₂— groups or two or more non-adjacent —CH₂— groups in the groups are each independently optionally replaced with —O— or —S—, and one or more hydrogen atoms present in R^{LC31}, R^{LC32}, R^{LC41}, R^{LC42}, R^{LC51}, and R^{LC52} are each independently optionally replaced with a fluorine or chlorine atom; A^{LC31}, A^{LC32}, A^{LC41}, A^{LC42}, A^{LC51}, and A^{LC52} are each independently trans-1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, 2,3-difluoro-1,4-phenylene, 1,4-cyclohexenylene, tetrahydropyran-2,5-diyl, 1,3-dioxane-2,5-diyl, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2, 6-diyl; Z^{LC31}, Z^{LC32}, Z^{LC41}, Z^{LC42}, Z^{LC51}, and Z^{LC52} are each independently a single bond, —CH═CH—, —C≡C—, —CH₂CH₂—, —(CH₂)₄—, —COO—, —OCO—, —OCH₂—, —CH₂O—, —OCF₂—, or —CF₂O—; Z⁵ is —CH₂— or an oxygen atom; X^{LC41} is a hydrogen or fluorine atom; and m^{LC31}, m^{LC32}, m^{LC41}, m^{LC42}, m^{LC51}, and m^{LC52} are each independently 0 to 3, where m^{LC31}+m^{LC32}=, m^{LC41}+m^{LC42}, and m^{LC51}+m^{LC52} are 1, 2, or 3, and each occurrence of A^{LC31} to A^{LC52} and Z^{LC31} to Z^{LC52} may be the same or different.)

The compounds represented by general formulas (LC3) to (LC5) preferably have an absolute value of negative dielectric anisotropy (Δ∈) of more than 3.

In general formulas (LC3) to (LC5), R^{LC31}, R^{LC41}, and R^{LC51} are preferably each independently an alkyl group of 1 to 7 carbon atoms, an alkoxyl group of 1 to 7 carbon atoms, an alkenyl group of 2 to 7 carbon atoms, or an alkenyloxy group of 2 to 7 carbon atoms, more preferably an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms, even more preferably an alkyl group of 1 to 5 carbon atoms or an alkenyl group of 2 to 5 carbon atoms, still more preferably an alkyl group of 2 to 5 carbon atoms or an alkenyl group of 2 or 3 carbon atoms, yet more preferably an alkenyl group of 3 carbon atoms (i.e., propenyl). R^{LC32}, R^{LC42}, and R^{LC52} are preferably each independently an alkyl group of 1 to 7 carbon atoms, an alkoxyl group of 1 to 7 carbon atoms, an alkenyl group of 2 to 7 carbon atoms, or an alkenyloxy group of 2 to 7 carbon atoms, more preferably an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms, even more preferably an alkoxyl group of 1 to 4 carbon atoms. If R^{LC31}, R^{LC32}, R^{LC41}, R^{LC42}, R^{LC51}, or R^{LC52} is an alkenyl group, it is preferably selected from groups represented by formulas (R1) to (R5). (In each formula, the black dot is the point of linkage to the ring.)

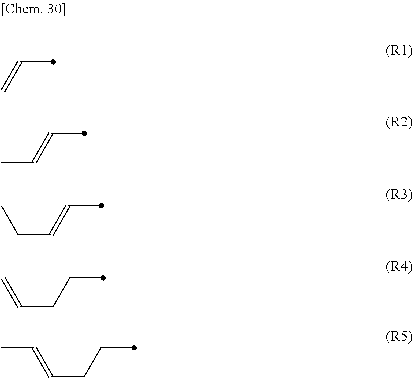

A^{LC31}, A^{LC32}, A^{LC41}, A^{LC42}, A^{LC51}, and A^{LC52} are preferably each independently 1,4-phenylene or trans-1,4-cyclohexylene.

Z^{LC31} to Z^{LC51} are preferably each independently a single bond, —CH₂O—, —COO—, —OCO—, —CH₂CH₂—, —CF₂O—, —OCF₂—, or —OCH₂—.

m^{LC31}, m^{LC32}, m^{LC41}, m^{LC42}, m^{LC51}, and m^{LC52} are preferably each independently 1 or 2.

As the compounds represented by general formula (LC3), the liquid crystal composition according to the present invention preferably contains one or more compounds represented by general formula (II-1).

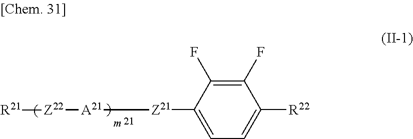

(In the formula, R²¹ and R²² are each independently an alkyl group of 1 to 10 carbon atoms, an alkoxyl group of 1 to 10 carbon atoms, an alkenyl group of 2 to 10 carbon atoms, or an alkenyloxy group of 2 to 10 carbon atoms, where one or more non-adjacent —CH₂— groups present in R²¹ and R²² are each independently optionally replaced with —O— or —S—, and one or more hydrogen atoms present in R²¹ and R²² are each independently optionally replaced with a fluorine or chlorine atom; A²¹ is trans-1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, 2,3-difluoro-1,4-phenylene, 1,4-cyclohexenylene, tetrahydropyran-2,5-diyl, 1,3-dioxane-2,5-diyl, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl; Z²¹ is —OCH₂—, —CH₂O—, —CF₂O—, —OCF₂—, —CH₂CH₂—, or —CF₂CF₂—; Z²² is —OCH₂—, —CH₂O—, —CF₂O—, —OCF₂—, —CH₂CH₂—, —CF₂CF₂—, or a single bond, with the proviso that Z²² directly linked to R²¹ is a single bond; and m²¹ is 1, 2, or 3, where each occurrence of A²¹ and Z²² may be the same or different.) The compounds represented by general formula (II-1) preferably have an absolute value of negative dielectric anisotropy (Δ∈) of more than 3.

In general formula (II-1), R²¹ is preferably an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms, more preferably an alkyl group of 1 to 5 carbon atoms or an alkenyl group of 2 to 5 carbon atoms, even more preferably an alkyl group of 2 to 5 carbon atoms or an alkenyl group of 2 or 3 carbon atoms, still more preferably an alkenyl group of 3 carbon atoms (i.e., propenyl). R²² is preferably an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms, more preferably an alkoxyl group of 1 to 4 carbon atoms.

If R²¹ or R²² is an alkenyl group, it is preferably selected from groups represented by formulas (R1) to (R5). (In each formula, the black dot is the point of linkage to the ring.)

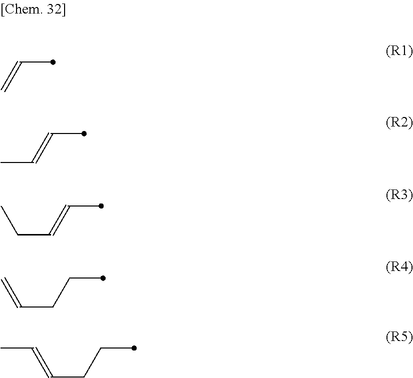

In general formula (II-1), A²¹ is trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl, preferably trans-1,4-cyclohexylene or 1,4-phenylene.

Z²¹ is —OCH₂—, —CH₂O—, —CF₂O—, —OCF₂—, —CH₂CH₂—, or —CF₂CF₂—, preferably —CH₂O—, —CF₂O—, —CH₂CH₂—, or —CF₂CF₂, more preferably —CH₂O— or —CH₂CH₂—, even more preferably —CH₂O—.

Z²² is —OCH₂—, —CH₂O—, —CF₂O—, —OCF₂—, —CH₂CH₂—, —CF₂CF₂—, or a single bond, preferably —CH₂O—, —CF₂O—, —CH₂CH₂—, —CF₂CF₂—, or a single bond, more preferably —CH₂O—, —CH₂CH₂—, or a single bond, even more preferably —CH₂O— or a single bond, with the proviso that Z²² directly linked to R²¹ is a single bond.

m²¹ is 1, 2, or 3, where each occurrence of A²¹ and Z²² may be the same or different.

Preferred compounds represented by general formula (II-1) include compounds represented by general formulas (II-1A) and (II-1B).

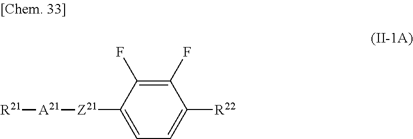

(In the formula, R²¹, R²², A²¹, and Z²¹ are each independently as defined for R²¹, R²², A²¹, and Z²¹, respectively, in general formula (II-1).)

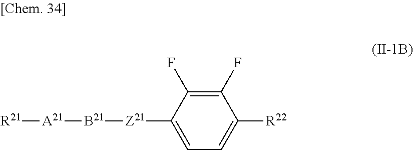

(In the formula, B²¹ is trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2, 6-diyl; and R²¹, R²², A²¹, and Z²¹; are each independently as defined for R²¹, R²², A²¹, and Z²¹, respectively, in general formula (II-1).)

Preferred compounds represented by general formula (II-1A) include compounds represented by general formulas (II-1A-1) to (II-1A-4) below, more preferably compounds represented by general formulas (II-1A-1) and (II-1A-4), even more preferably compounds represented by general formula (II-1A-1).

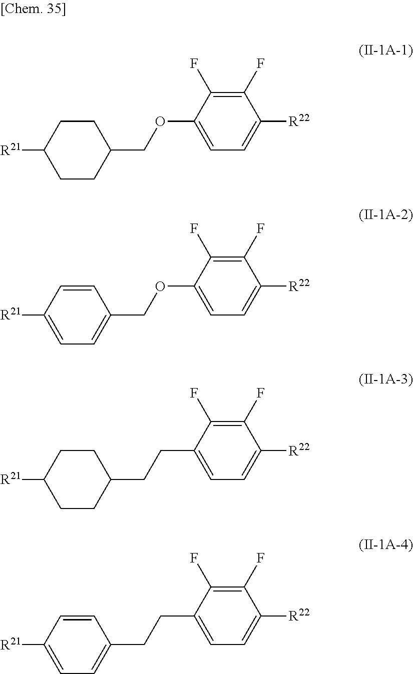

(In the formulas, R²¹ and R²² are each independently as defined for R²¹ and R²², respectively, in general formula (II-1).)

Preferred compounds represented by general formula (II-1B) include compounds represented by general formulas (II-1B-1) to (II-1B-6) below, more preferably compounds represented by general formulas (II-1B-1), (II-1B-3), and (II-1B-6), even more preferably compounds represented by general formulas (II-1B-1) and (II-1B-3).

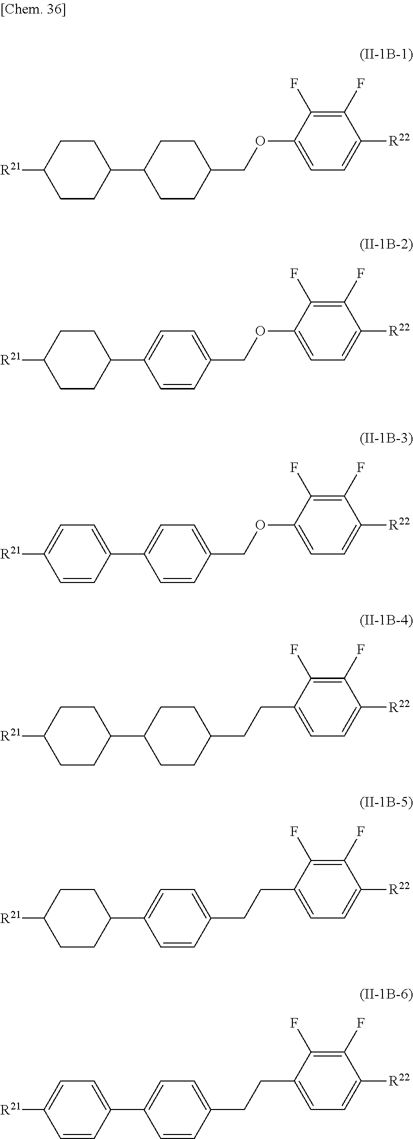

(In the formulas, R²¹ and R²² are each independently as defined for R²¹: and R²², respectively, in general formula (II-1).)

The liquid crystal composition according to the present invention may contain at least one or more compounds represented by either general formula (II-1A) or (II-1B), or may contain both one or more compounds represented by general formula (II-1A) and one or more compounds represented by general formula (II-1B). Preferably, the liquid crystal composition according to the present invention contains one or more, more preferably two to ten, compounds selected from compounds represented by general formulas (II-1A) and (II-1B).

More specifically, as the compounds represented by general formulas (II-1A) and (II-1B), the liquid crystal composition according to the present invention preferably contains one or more compounds selected from the group consisting of compounds represented by general formulas (II-1A-1) and (II-1B-1), more preferably a combination of compounds represented by general formulas (II-1A-1) and (II-1B-1).

The compounds represented by general formula (II-1) are preferably present in an amount of 10% to 90% by mass, more preferably 20% to 80% by mass, more preferably 20% to 70% by mass, more preferably 20% to 60% by mass, more preferably 20% to 55% by mass, more preferably 25% to 55% by mass, more preferably 30% to 55% by mass.

More specifically, the compounds represented by general formula (II-1) are preferably present in the composition in an amount, as the lower limit, of 1% by mass (hereinafter the percentages in the composition are by mass) or more, more preferably 5% or more, more preferably 10% or more, more preferably 13% or more, more preferably 15% or more, more preferably 18% or more, more preferably 20% or more, more preferably 23% or more, more preferably 25% or more, more preferably 28% or more, more preferably 30% or more, more preferably 33% or more, more preferably 35% or more, more preferably 38% or more, more preferably 40% or more. The compounds represented by general formula (II-1) are preferably present in an amount, as the upper limit, of 95% or less, more preferably 90% or less, more preferably 88% or less, more preferably 85% or less, more preferably 83% or less, more preferably 80% or less, more preferably 78% or less, more preferably 75% or less, more preferably 73% or less, more preferably 70% or less, more preferably 68% or less, more preferably 65% or less, more preferably 63% or less, more preferably 60% or less, more preferably 55% or less, more preferably 50% or less, more preferably 40% or less.

As the compounds represented by general formula (LC3), the liquid crystal composition according to the present invention preferably contains one or more compounds represented by general formula (II-2).

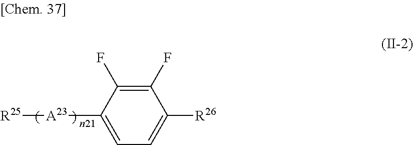

(In the formula, R²⁵ and R²⁶ are each independently an alkyl group of 1 to 10 carbon atoms, an alkoxyl group of 1 to 10 carbon atoms, an alkenyl group of 2 to 10 carbon atoms, or an alkenyloxy group of 2 to 10 carbon atoms, where one or more non-adjacent —CH₂— groups present in R²⁵ and R²⁶ are each independently optionally replaced with —O— or —S—, and one or more hydrogen atoms present in R²⁵ and R²⁶ are each independently optionally replaced with a fluorine or chlorine atom; A²³ is trans-1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, 2,3-difluoro-1,4-phenylene, 1,4-cyclohexenylene, tetrahydropyran-2,5-diyl, 1,3-dioxane-2,5-diyl, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl; and n²¹ is 1, 2, or 3, where each occurrence of A²³ may be the same or different.) In general formula (II-2), R²⁵ is preferably each independently an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms, more preferably an alkyl group of 1 to 5 carbon atoms or an alkenyl group of 2 to 5 carbon atoms, even more preferably an alkyl group of 2 to 5 carbon atoms or an alkenyl group of 2 or 3 carbon atoms, still more preferably an alkenyl group of 3 carbon atoms (i.e., propenyl). R²⁶ is preferably each independently an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms, more preferably an alkoxyl group of 1 to 4 carbon atoms. If R²⁵ or R²⁶ is an alkenyl group, it is preferably selected from groups represented by formulas (R1) to (R5). (In each formula, the black dot is the point of linkage to the ring.)

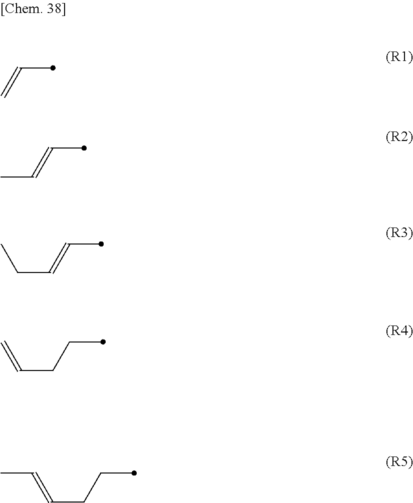

A²³ is preferably 1,4-phenylene or trans-1,4-cyclohexylene.

n²¹ is preferably 1 or 2.

Preferred compounds represented by general formula (II-2) include compounds represented by general formulas (II-2A) and (II-2B).

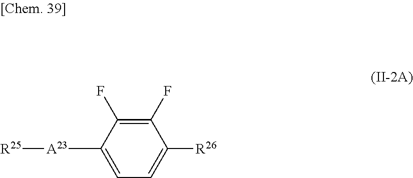

(In the formula, R²⁵, R²⁶, and A²³ are as defined for R²⁵, R²⁶, and A²³, respectively, in general formula (II-2).)

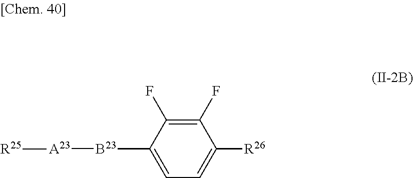

(In the formula, B²³ is trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2, 6-diyl; and R²⁵, R²⁶, and A²³ are each independently as defined for R²⁵, R²⁶, and A²³, respectively, in general formula (II-2).)

Preferred compounds represented by general formula (II-2A) include compounds represented by general formulas (II-2A-1) and (II-2A-2) below, more preferably compounds represented by general formula (II-2A-2).

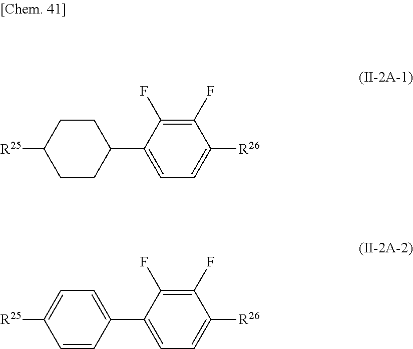

(In the formulas, R²⁵ and R²⁶ are as defined for R²⁵ and R²⁶, respectively, in general formula (II-2).)

Preferred compounds represented by general formula (II-2B) include compounds represented by general formulas (II-2B-1) to (II-2B-3) below, more preferably compounds represented by general formulas (II-2B-1) and (II-2B-2), even more preferably compounds represented by general formula (II-2B-2).

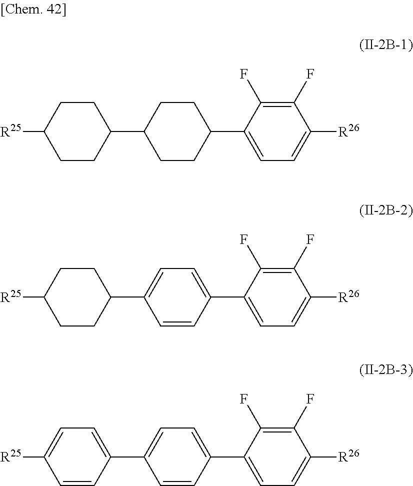

(In the formulas, R²⁵ and R²⁶ are as defined for R²⁵ and R²⁶, respectively, in general formula (II-2).)

As the compounds represented by general formula (LC3), the liquid crystal composition according to the present invention preferably contains one or more compounds represented by general formula (LC3-b) below.

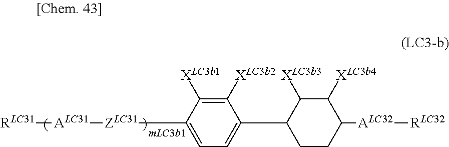

(In the formula, R^{LC31}, R^{LC32}, A^{LC31}, A^{LC32}, and Z^{LC31} are as defined for R^{LC31}, R^{LC32}, A^{LC31}, A^{LC32}, and Z^{LC31}, respectively, in general formula (LC3); X^{LC3b1} to X^{LC3b4} are a hydrogen or fluorine atom, with the proviso that both X^{LC3b1} and X^{LC3b2} and/or both X^{LC3b3} and X^{LC3b4} are fluorine atoms; and m^{LC3b1} is 0 or 1, with the proviso that compounds represented by general formulas (II-1) and (II-2) are excluded from the compounds represented by general formula (LC3-b).)

Preferred compounds represented by general formula (LC3-b) include compounds represented by general formulas (LC3-b1) to (LC3-b10) below, more preferably compounds represented by general formulas (LC3-b1), (LC3-b3), and (LC3-b4), even more preferably compounds represented by general formula (LC3-b1). Preferably, the liquid crystal composition according to the present invention necessarily contains a compound represented by general formula (LC3-b1).

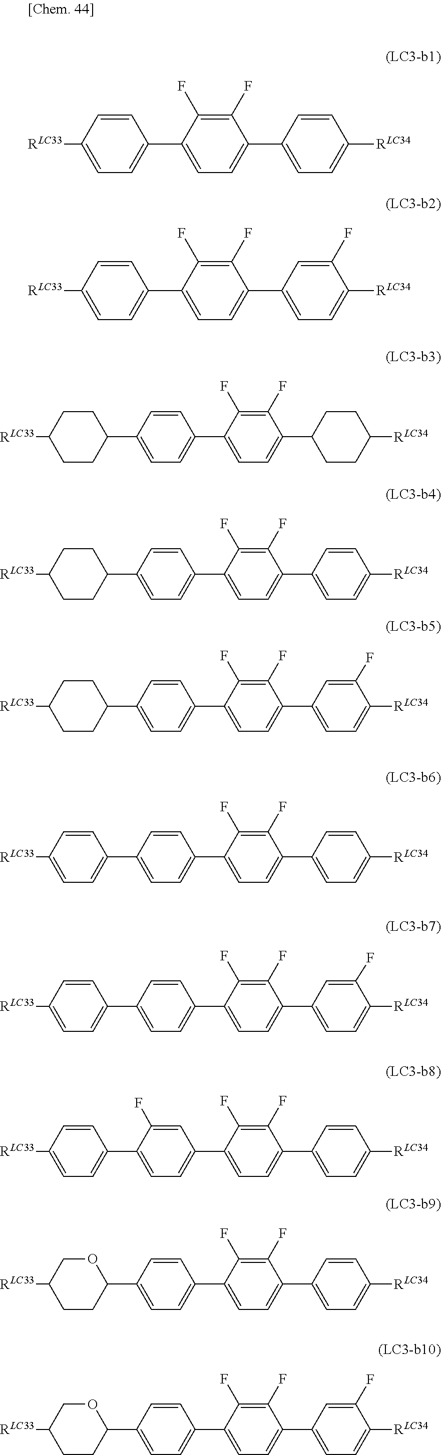

(In the formulas, R^{LC33} and R^{LC34} are each independently an alkyl group of 1 to 8 carbon atoms, an alkoxyl group of 1 to 8 carbon atoms, an alkenyl group of 2 to 8 carbon atoms, or an alkenyloxyl group of 2 to 8 carbon atoms.)

Preferred combinations of R^{LC33} and R^{LC34} include, but not limited to, two alkyl groups, two alkenyl groups, one alkyl group with one alkenyl group, one alkyl group with one alkoxy group, and one alkyl group with one alkenyloxy group, more preferably two alkyl groups and two alkenyl groups.

Other preferred compounds represented by general formula (LC3-b) include compounds represented by general formula (LC3-b11) below. Preferably, the liquid crystal composition according to the present invention necessarily contains a compound represented by general formula (LC3-b11).

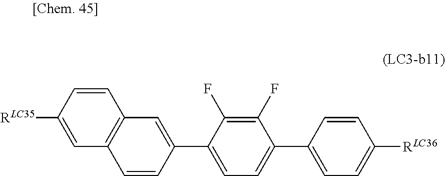

(In the formula, R^{LC35} and R^{LC36} are each independently an alkyl group of 1 to 8 carbon atoms, an alkoxyl group of 1 to 8 carbon atoms, an alkenyl group of 2 to 8 carbon atoms, or an alkenyloxyl group of 2 to 8 carbon atoms.)

As the compounds represented by general formula (LC3), the liquid crystal composition according to the present invention preferably contains one or more compounds represented by general formula (PAP-1).

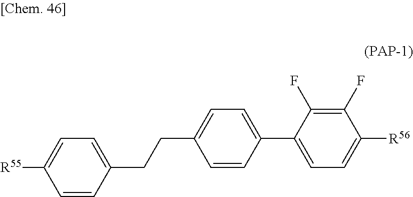

(In the formula, R⁵⁵ and R⁵⁶ are each independently an alkyl group of 1 to 8 carbon atoms, an alkoxy group of 1 to 8 carbon atoms, an alkenyl group of 2 to 8 carbon atoms, or an alkenyloxy group of 2 to 8 carbon atoms, where one or more hydrogen atoms in the groups are optionally replaced with a fluorine atom.)

R⁵⁵ is preferably an alkyl group of 1 to 5 carbon atoms, an alkoxy group of 1 to 4 carbon atoms, an alkenyl group of 2 to 5 carbon atoms, or an alkenyloxy group of 2 to 5 carbon atoms, more preferably an alkyl group of 1 to 5 carbon atoms or an alkenyl group of 2 to 5 carbon atoms. R⁵⁶ is preferably an alkyl group of 1 to 5 carbon atoms, an alkoxy group of 1 to 4 carbon atoms, an alkenyl group of 2 to 5 carbon atoms, or an alkenyloxy group of 2 to 5 carbon atoms, more preferably an alkyl group of 1 to 5 carbon atoms or an alkoxy group of 1 to 5 carbon atoms, even more preferably an alkoxy group of 1 to 5 carbon atoms. Preferred compounds represented by general formula (LC4) include compounds represented by general formulas (LC4-a) to (LC4-c) below, and preferred compounds represented by general formula (LC5) include compounds represented by general formulas (LC5-a) to (LC5-c) below.

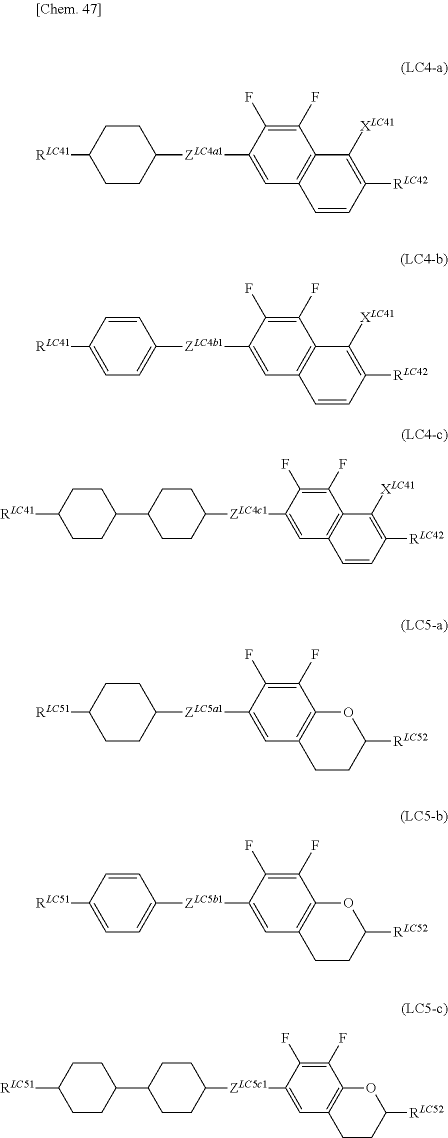

(In the formulas, R^{LC41}, R^{LC42}, and X^{LC41} are each independently as defined for R^{LC41}, R^{LC42}, and X^{LC41}, respectively, in general formula (LC4); R^{LC51} and R^{LC52} are each independently as defined for R^{LC51} and R^{LC52}, respectively, in general formula (LC5); and Z^{LC4a1}, Z^{LC4b1}, Z^{LC4c1}, Z^{LC5a1}, Z^{LC5b1}, and Z^{LC5c1} are each independently a single bond, —CH═CH—, —C≡C—, —CH₂CH₂—, —(CH₂)₄—, —COO—, —OCH₂—, —CH₂O—, —OCF₂—, or —CF₂O—.) More preferably, the liquid crystal composition according to the present invention contains one or more compounds selected from the group consisting of compounds represented by general formulas (LC4-a) to (LC4-c) and (LC5-a) to (LC5-c).

As the compounds represented by general formula (LC3), the liquid crystal composition according to the present invention may contain at least one or more compounds represented by any of general formulas (II-1A), (II-1B), (II-2A), and (II-2B), may contain both one or more compounds represented by general formula (II-1A) and one or more compounds represented by general formula (II-1B), or may contain both one or more compounds represented by general formula (II-2A) and one or more compounds represented by general formula (II-2B). Preferably, the liquid crystal composition according to the present invention contains one or more, more preferably two to ten, compounds selected from the group consisting of compounds represented by general formulas (II-1A), (II-1B), (II-2A), and (II-2B).

More specifically, the compounds represented by general formula (LC3) are preferably a combination of compounds represented by general formulas (II-2A-1) and (II-2B-1), more preferably a combination of compounds represented by general formulas (II-2A-1), (II-2B-1), and (II-2B-2).

More specifically, the compounds represented by general formula (LC3) are preferably a combination of compounds represented by general formulas (II-2A-2) and (II-2B-1).

More specifically, the compounds represented by general formula (LC3) are preferably a combination of compounds represented by general formulas (II-1A-1), (II-1B-1), and (II-2A-1), more preferably a combination of compounds represented by general formulas (II-1A-1), (II-1B-1), and (II-2A-2).

More specifically, the compounds represented by general formula (LC3) are preferably a combination of compounds represented by general formulas (II-2A-1), (II-2B-1), and (II-1B-1).

More specifically, the compounds represented by general formula (LC3) are preferably a combination of compounds represented by general formulas (II-2A-2) and (II-1B-1), more preferably a combination of compounds represented by general formulas (II-2A-2), (II-1B-1), and (II-2B-2), even more preferably a combination of compounds represented by general formulas (II-2A-2), (II-1B-1), and (II-1B-3).

More specifically, the compounds represented by general formula (LC3) are preferably a combination of compounds represented by general formulas (II-1A-1), (II-1B-1), and (LC3-b), more preferably a combination of compounds represented by general formulas (II-1A-1), (II-1B-1), and (LC3-b1), even more preferably a combination of compounds represented by general formulas (II-1A-1), (II-1B-1), and (LC3-b11).

The liquid crystal composition according to the present invention preferably contains one or more compounds selected from the group consisting of compounds represented by general formula (LC3) where Ru^{LC31} is a propenyl group, compounds represented by general formula (LC4) where R^{LC41} is a propenyl group, and compounds represented by general formula (LC5) where R^{LC51} is a propenyl group.

The compounds represented by general formulas (LC3) to (LC5) are preferably present in an amount of 0.5% to 95% by mass, more preferably 10% to 90% by mass, more preferably 20% to 80% by mass, more preferably 20% to 70% by mass, more preferably 20% to 60% by mass, more preferably 20% to 55% by mass, more preferably 25% to 55% by mass, more preferably 30% to 55% by mass.

More specifically, the compounds represented by general formulas (LC3) to (LC5) are preferably present in the composition in an amount, as the lower limit, of 0.5% or more, more preferably 1% or more, more preferably 2% or more, more preferably 3% or more, more preferably 4% or more, more preferably 5% or more, more preferably 10% or more, more preferably 15% or more, more preferably 20% or more, more preferably 25% or more, more preferably 30% or more, more preferably 35% or more, more preferably 38% or more, more preferably 40% or more. The compounds represented by general formulas (LC3) to (LC5) are preferably present in an amount, as the upper limit, of 95% or less, more preferably 90% or less, more preferably 88% or less, more preferably 85% or less, more preferably 83% or less, more preferably 80% or less, more preferably 78% or less, more preferably 75% or less, more preferably 73% or less, more preferably 70% or less, more preferably 68% or less, more preferably 65% or less, more preferably 63% or less, more preferably 60% or less, more preferably 55% or less, more preferably 50% or less, more preferably 40% or less, more preferably 30% or less, more preferably 20% or less.

The compounds selected from the group consisting of compounds represented by general formulas (LC3) to (LC5) are preferably present in the liquid crystal composition according to the present invention in an amount of 10% to 90% by mass, more preferably 20% to 80% by mass, even more preferably 30% to 70% by mass.

More specifically, the compounds represented by general formulas (LC3) to (LC5) are preferably present in the composition in an amount, as the lower limit, of 1% by mass (hereinafter the percentages in the composition are by mass) or more, more preferably 5% or more, more preferably 10% or more, more preferably 13% or more, more preferably 15% or more, more preferably 18% or more, more preferably 20% or more, more preferably 23% or more, more preferably 25% or more, more preferably 28% or more, more preferably 30% or more, more preferably 33% or more, more preferably 35% or more, more preferably 38% or more, more preferably 40% or more. The compounds represented by general formulas (LC3) to (LC5) are preferably present in an amount, as the upper limit, of 95% or less, more preferably 90% or less, more preferably 88% or less, more preferably 85% or less, more preferably 83% or less, more preferably 80% or less, more preferably 78% or less, more preferably 75% or less, more preferably 73% or less, more preferably 70% or less, more preferably 68% or less, more preferably 65% or less, more preferably 63% or less, more preferably 60% or less, more preferably 55% or less, more preferably 50% or less, more preferably 40% or less.

The liquid crystal composition according to the present invention preferably contains one or more compounds represented by general formula (III).

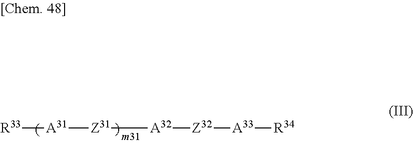

(In the formula, R³³ and R³⁴ are each independently an alkyl group of 1 to 15 carbon atoms, where one or more —CH₂— groups in the alkyl group are optionally replaced with —O—, —CH═CH—, —CO—, —OCO—, —COO—, —C≡C—, —CF₂O—, or —OCF₂—, with the proviso that no oxygen atoms are directly adjacent to each other, and one or more hydrogen atoms in the alkyl group are optionally replaced with halogen; A³¹ to A³³ are each independently trans-1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, 1,4-cyclohexenylene, tetrahydropyran-2,5-diyl, 1,3-dioxane-2,5-diyl, 1,4-bicyclo[2.2.2]octylene, naphthalene-2,6-diyl, decahydronaphthalene-2,6-diyl, or 1,2,3,4-tetrahydronaphthalene-2,6-diyl; Z³¹ and Z³¹ are each independently a single bond, —CH═CH—, —C≡C—, —CH₂CH₂—, —(CH₂)₄—, —OCH₂—, —CH₂O—, —OCF₂—, or —CF₂O—; and m³¹ is 0, 1, or 2, where each occurrence of A³¹ and Z³¹ may be the same or different, with the proviso that compounds represented by general formula (I-IV) are excluded from the compounds represented by general formula (III).)

In general formula (III), R³³ and R³⁴ are preferably each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms, and are preferably linear. If R³³ or R³⁴ is an alkenyl group, it is preferably selected from groups represented by formulas (R¹) to (R⁵).

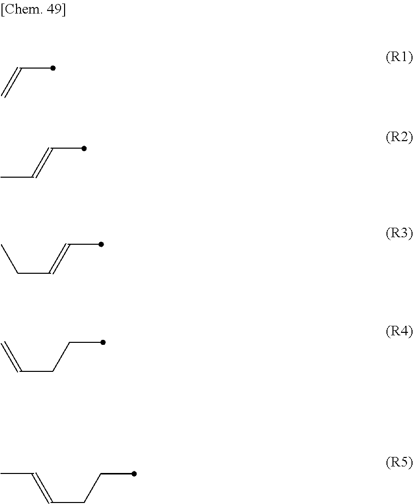

(In each formula, the black dot is the point of linkage to the ring.)

Preferred combinations of R³³ and R³⁴ include, but not limited to, two alkyl groups, one alkyl group with one alkenyl group, one alkyl group with one alkoxy group, and one alkyl group with one alkenyloxy group.

A³¹ to A³³ are preferably each independently any of the following structures.

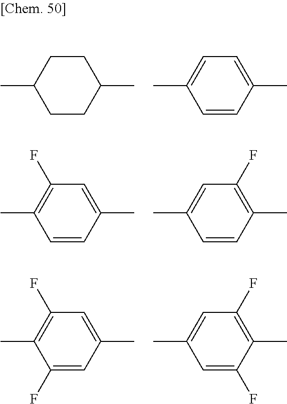

More preferably, A³¹ to A³³ are each independently any of the following structures.

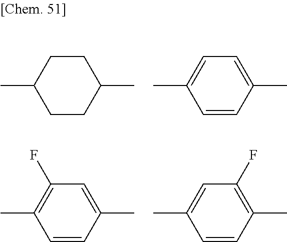

Z³³ and Z³² are each independently a single bond, —CH═CH—, —C≡C—, —CH₂CH₂—, —(CH₂)₄—, —OCH₂—, —CH₂O—, —OCF₂—, or —CF₂O—, preferably a single bond, —CH₂CH₂—, —OCF₂—, or —CF₂O—, more preferably a single bond.

m³¹ is preferably an integer of 1 or 2. Each occurrence of A³¹ and Z³¹ may be the same or different.

Preferred compounds represented by general formula (III) include compounds represented by general formulas (III-B) to (III-K) below. As the compounds represented by general formula (III), the liquid crystal composition according to the present invention preferably contains one or more of compounds represented by general formulas (III-B) to (III-K).

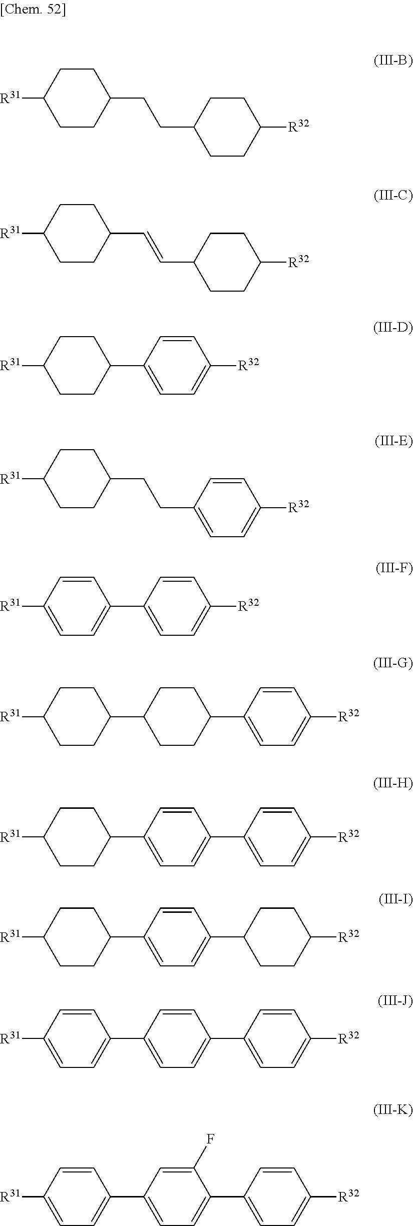

(In the formulas, R³¹ and R³² are an alkyl group of 1 to 5 carbon atoms or an alkenyl group of 2 to 5 carbon atoms; and R³ is an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms.)

The compounds represented by general formula (III) are preferably selected from compounds represented by general formulas (III-D), (III-F), (III-G), and (III-H), more preferably compounds represented by general formulas (III-F), (III-G), and (III-H), even more preferably compounds represented by general formulas (III-G) and (III-H), and are also preferably selected from compounds represented by general formulas (III-F) and (III-H). More specifically, compounds selected from compounds represented by general formulas (III-F), (III-H), and (III-K) are preferred if a large Δn is required.

Preferred compounds represented by general formulas (III-D), (III-G), and (III-H) include those where R³¹ is an alkyl group of 1 to 5 carbon atoms or an alkenyl group of 2 to 5 carbon atoms, and R³² is an alkyl group of 1 to 5 carbon atoms or an alkoxy group of 1 to 5 carbon atoms, more preferably those where R³¹ is an alkenyl group of 2 to 5 carbon atoms, even more preferably those where R^{3′} is an alkenyl group of 2 or 3 carbon atoms. Preferred compounds represented by general formula (III-F) include those where R³¹ and R³² are each independently an alkyl group of 1 to 5 carbon atoms or an alkenyl group of 2 to 5 carbon atoms.

Specific examples of preferred compounds represented by general formulas (III-B) to (III-K) include the following compounds.

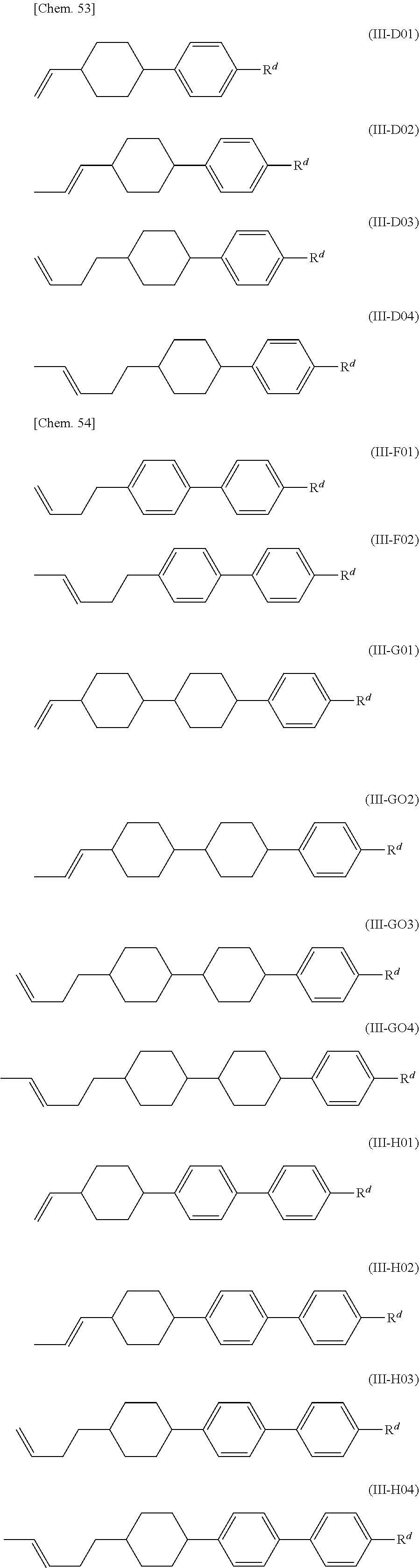

(In the formulas, R^{d} is an alkyl group of 1 to 5 carbon atoms, an alkoxyl group of 1 to 5 carbon atoms, an alkenyl group of 2 to 5 carbon atoms, or an alkenyloxy group of 2 to 5 carbon atoms, with the proviso that compounds represented by general formulas (I-V) and (I-V1) are excluded.)

As the compounds represented by general formula (III), the liquid crystal composition according to the present invention preferably contains one or more of compounds represented by general formulas (VIII-a), (VIII-c), and (VIII-d).

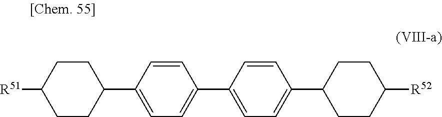

(In the formula, R⁵¹ and R⁵² are each independently an alkyl group of 1 to 5 carbon atoms, an alkenyl group of 2 to 5 carbon atoms, or an alkoxy group of 1 to 4 carbon atoms.)

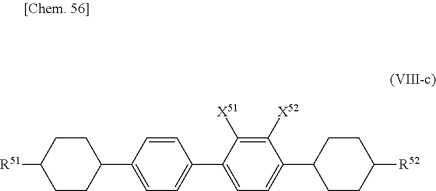

(In the formula, R⁵¹ and R⁵² are each independently an alkyl group of 1 to 5 carbon atoms, an alkenyl group of 2 to 5 carbon atoms, or an alkoxy group of 1 to 4 carbon atoms; and X⁵¹ and X⁵² are each independently a fluorine or hydrogen atom, with the proviso that one of X⁵¹ and X⁵² is a fluorine atom, and the other is a hydrogen atom.)

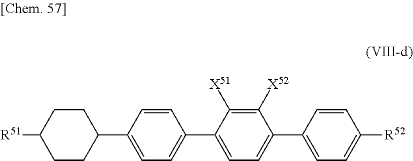

(In the formula, R⁵¹ and R⁵² are each independently an alkyl group of 1 to 5 carbon atoms, an alkenyl group of 2 to 5 carbon atoms, or an alkoxy group of 1 to 4 carbon atoms; and X⁵¹ and X⁵² are each independently a fluorine or hydrogen atom, with the proviso that one of X⁵¹ and X⁵² is a fluorine atom, and the other is a hydrogen atom.)

As the compounds represented by general formula (III), the liquid crystal composition according to the present invention may contain one or more of compounds represented by general formulas (V-9.1) to (V-9.3).

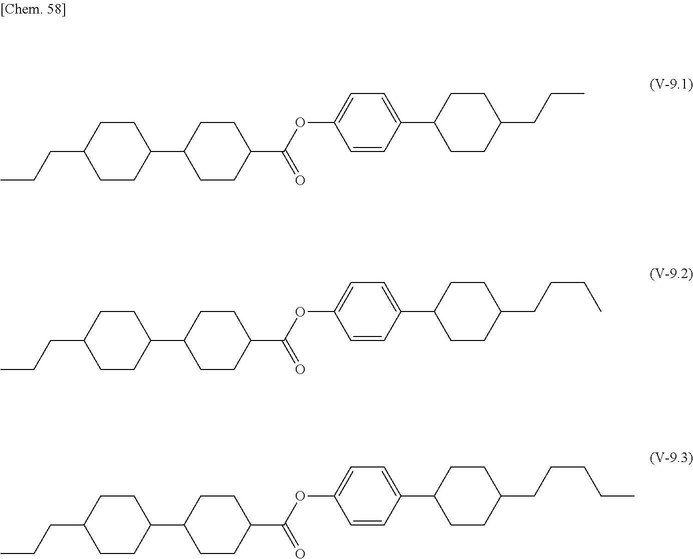

The compounds represented by general formula (III) are preferably present in an amount of 1% to 60% by mass, more preferably 10% to 50% by mass, even more preferably 20% to 50% by mass, still more preferably 20% to 40% by mass.

More specifically, the compounds represented by general formula (III) are preferably present in the composition in an amount, as the lower limit, of 0.5% by mass (hereinafter the percentages in the composition are by mass) or more, more preferably 1% or more, more preferably 3% or more, more preferably 5% or more, more preferably 8% or more, more preferably 10% or more, more preferably 13% or more, more preferably 15% or more, more preferably 18% or more, more preferably 20% or more. The compounds represented by general formula (III) are preferably present in an amount, as the upper limit, of 80% or less, more preferably 70% or less, more preferably 65% or less, more preferably 60% or less, more preferably 55% or less, more preferably 50% or less, more preferably 45% or less, more preferably 40% or less, more preferably 38% or less, more preferably 35% or less, more preferably 33% or less, more preferably 30% or less, more preferably 28% or less, more preferably 25% or less.

As the compounds represented by general formula (III), the liquid crystal composition according to the present invention may contain one or more compounds represented by general formula (N-001).

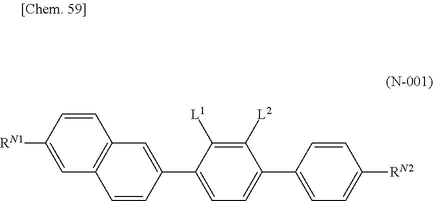

(In the formula, R^{N1} and R^{N2} are each independently an alkyl group of 1 to 8 carbon atoms, an alkoxyl group of 1 to 8 carbon atoms, an alkenyl group of 2 to 8 carbon atoms, or an alkenyloxyl group of 2 to 8 carbon atoms; and L¹ and L² are each independently a hydrogen atom, a fluorine atom, CH₃, or CF₃, with the proviso that L¹ and L² are not both fluorine atoms.)

R^{N1} and R^{N2} are preferably an alkyl group of 1 to 5 carbon atoms.

The liquid crystal composition according to the present invention preferably simultaneously contains compounds represented by general formulas (I-IV), (I), (II-1A-1), and (III-F); compounds represented by general formulas (I-IV), (I), (II-1A-1), and (III-H); compounds represented by general formulas (I-IV), (I), (II-1), (II-2A-1), and (III-F); compounds represented by general formulas (I-IV), (I), (II-1), (II-2A-1), and (III-H); compounds represented by general formulas (I-IV), (I), (II-1), (II-2A-2), and (III-F); compounds represented by general formulas (I-IV), (I-1), (II), (II-2A-2), and (III-H); compounds represented by general formulas (I-IV), (I), (II-1B-1), and (III-F); compounds represented by general formulas (I-IV), (I), (II-1B-1), and (III-H); compounds represented by general formulas (I-IV), (I), (II-1B-3), and (III-F); compounds represented by general formulas (I-IV), (I), (II-1B-3), and (III-H); compounds represented by general formulas (I-IV), (I), (II-2B-1), and (III-F); compounds represented by general formulas (I-IV), (I), (II-1), (II-2B-1), and (III-H); compounds represented by general formulas (I-IV), (I), (II-2B-2), and (III-F); or compounds represented by general formulas (I-IV), (I), (II-1), (II-2B-2), and (III-H).

More preferably, the liquid crystal composition according to the present invention simultaneously contains compounds represented by general formulas (I-IV), (I), (II-1A-1), (II-1B-1), and (III-H); compounds represented by general formulas (I-IV), (I), (II-1A-1), (II-1B-1), and (III-H); compounds represented by general formulas (I-IV), (I), (II-1), (II-2A-1), (II-2B-2), and (III-H); compounds represented by general formulas (I-IV), (I), (II-1A-1), (II-2B-1), and (III-H); or compounds represented by general formulas (I-IV), (I), (II-1A-1), (II-2B-2), and (III-H).

More preferably, the liquid crystal composition according to the present invention simultaneously contains compounds represented by general formulas (I-IV), (I), (II-1), (II-2A-2), (II-2B-2), and (III-K); compounds represented by general formulas (I-IV), (I), (II-1A-1), (II-1B-1), and (III-K); or compounds represented by general formulas (I-IV), (I), (II-1A-1), (II-1B-1), (II-1B-3), and (III-K).

The compounds represented by general formula (I-IV), the compounds represented by general formula (I), and the compounds represented by general formula (II-1) are preferably present in the liquid crystal composition according to the present invention in a total amount of 50% to 99% by mass, more preferably 55% to 99% by mass, even more preferably 60% to 99% by mass, still more preferably 65% to 99% by mass, yet more preferably 70% to 99% by mass, further preferably 75% to 99% by mass.

More specifically, the compounds represented by general formula (I-IV), the compounds represented by general formula (I), and the compounds represented by general formula (II-1) are preferably present in the composition in a total amount, as the lower limit, of 30% by mass (hereinafter the percentages in the composition are by mass) or more, more preferably 35% or more, more preferably 40% or more, more preferably 45% or more, more preferably 50% or more, more preferably 55% or more, more preferably 60% or more, more preferably 65% or more, more preferably 70% or more, more preferably 75% or more, more preferably 78% or more, more preferably 80% or more, more preferably 83% or more, more preferably 85% or more, more preferably 90% or more, more preferably 91% or more. The compounds represented by general formula (I-IV), the compounds represented by general formula (I), and the compounds represented by general formula (II-1) are preferably present in a total amount, as the upper limit, of 100% or less, more preferably 99% or less, more preferably 95% or less, more preferably 90% or less, more preferably 85% or less, more preferably 80% or less, more preferably 75% or less, more preferably 70% or less, more preferably 65% or less, more preferably 60% or less, more preferably 55% or less, more preferably 50% or less.

The compounds represented by general formula (I-IV), the compounds represented by general formula (I), the compounds represented by general formula (II-1), and the compounds selected from the group consisting of compounds represented by general formulas (LC3) to (LC5) are preferably present in the liquid crystal composition according to the present invention in a total amount of 50% to 99% by mass, more preferably 55% to 99% by mass, even more preferably 60% to 99% by mass, still more preferably 65% to 99% by mass, yet more preferably 70% to 99% by mass, further preferably 75% to 99% by mass. The compounds represented by general formula (I-IV), the compounds represented by general formula (I), the compounds selected from the group consisting of compounds represented by general formulas (LC3) to (LC5), and the compounds represented by general formula (III) are preferably present in the liquid crystal composition according to the present invention in a total amount of 70% to 100% by mass, more preferably 80% to 100% by mass, even more preferably 85% to 100% by mass, still more preferably 90% to 100% by mass, yet more preferably 95% to 100% by mass.

The liquid crystal composition according to the present invention has a dielectric anisotropy (Δ∈) at 25° C. of −2.0 to −8.0, preferably −2.0 to −6.0, more preferably −2.0 to −5.0, even more preferably −2.5 to −4.0.

The liquid crystal composition according to the present invention has a refractive index anisotropy (Δn) at 20° C. of 0.08 to 0.14, preferably 0.09 to 0.13, more preferably 0.09 to 0.12. More specifically, the refractive index anisotropy (Δn) preferred for small cell gaps is 0.10 to 0.13, whereas the refractive index anisotropy (Δn) preferred for large cell gaps is 0.08 to 0.10.

The liquid crystal composition according to the present invention has a viscosity (η) at 20° C. of 10 to 30 mPa·s, preferably 10 to 25 mPa·s, more preferably 10 to 22 mPa·s.

The liquid crystal composition according to the present invention has a rotational viscosity (γ1) at 20° C. of 60 to 130 mPa·s, preferably 60 to 110 mPa·s, more preferably 60 to 100 mPa·s.

The liquid crystal composition according to the present invention has a nematic-isotropic liquid phase transition temperature (Tₙᵢ) of 60° C. to 120° C., preferably 70° C. to 100° C., more preferably 70° C. to 85° C.

In addition to the compounds described above, the liquid crystal composition according to the present invention may contain other components such as common nematic, smectic, and cholesteric liquid crystals, antioxidants, UV absorbers, infrared absorbers, polymerizable monomers, and light stabilizers (HALS) other than those according to the present invention.

As an example of a common nematic or smectic liquid crystal, the liquid crystal composition according to the present invention may contain a liquid crystal compound having a dielectric anisotropy (Δ∈) at 25° C. of +2.0 to +50.0 in an amount of 0% to 50% by mass, preferably 1% to 30% by mass, more preferably 3% to 30% by mass, even more preferably 5% to 20% by mass.

As an example of a polymerizable monomer, the liquid crystal composition may contain a polymerizable compound such as a biphenyl or terphenyl derivative in an amount of 0.01% to 2% by mass.

As polymerizable monomers, the liquid crystal composition may contain one or more of polymerizable compounds containing one reactive group, i.e., monofunctional polymerizable compounds, and polymerizable compounds containing two or more reactive groups, i.e., polyfunctional polymerizable compounds, such as di- and trifunctional polymerizable compounds. These reactive-group-containing polymerizable compounds may or may not contain a mesogenic moiety.

The reactive groups of the reactive-group-containing polymerizable compounds are preferably photopolymerizable substituents.

Among reactive-group-containing polymerizable compounds, specific preferred monofunctional reactive-group-containing polymerizable compounds include polymerizable compounds represented by general formula (VI) below.

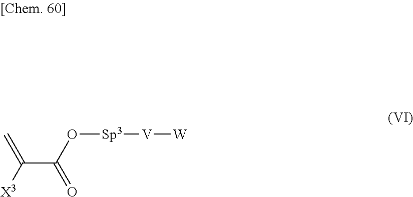

(In the formula, X³ is a hydrogen atom or a methyl group; Sp³ is a single bond, an alkylene group of 1 to 8 carbon atoms, or —O—(CH₂)ₜ— (where t is an integer of 2 to 7, and the oxygen atom is linked to the aromatic ring); V is a linear or branched polyvalent alkylene group of 2 to 20 carbon atoms or a polyvalent cyclic substituent of 5 to 30 carbon atoms, where the alkylene group in the polyvalent alkylene group is optionally substituted with an oxygen atom, with the proviso that no oxygen atoms are adjacent to each other, and is optionally substituted with an alkyl group of 5 to 20 carbon atoms (where the alkylene group in the group is optionally substituted with an oxygen atom, with the proviso that no oxygen atoms are adjacent to each other) or a cyclic substituent; and W is a hydrogen or halogen atom or an alkylene group of 1 to 8 carbon atoms.)

Although X³ in general formula (VI) above is a hydrogen atom or a methyl group, a hydrogen atom is preferred if a higher reaction rate is desired, whereas a methyl group is preferred if a lower residual monomer content is desired.

Although Sp³ in general formula (VI) above is a single bond, an alkylene group of 1 to 8 carbon atoms, or —O—(CH₂)ₜ— (where t is an integer of 2 to 7, and the oxygen atom is linked to the aromatic ring), shorter carbon chains are preferred. Specifically, Sp³ is preferably a single bond or an alkylene group of 1 to 5 carbon atoms, more preferably a single bond or an alkylene group of 1 to 3 carbon atoms. If Sp³ is —O—(CH₂)ₜ—, t is preferably 1 to 5, more preferably 1 to 3.

Although V in general formula (VI) above is a linear or branched polyvalent alkylene group of 2 to 20 carbon atoms or a polyvalent cyclic substituent of 5 to 30 carbon atoms, the alkylene group in the polyvalent alkylene group may be substituted with an oxygen atom, with the proviso that no oxygen atoms are adjacent to each other, and may be substituted with an alkyl group of 5 to 20 carbon atoms (where the alkylene group in the group is optionally substituted with an oxygen atom, with the proviso that no oxygen atoms are adjacent to each other) or a cyclic substituent, preferably with two or more cyclic substituents.

Specific polymerizable compounds represented by general formula (VI) include compounds represented by general formula (X1a).

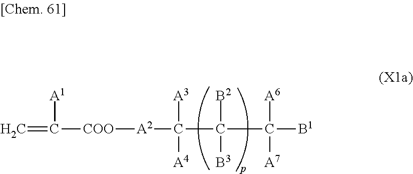

(In the formula,

A¹ is a hydrogen atom or a methyl group;

A² is a single bond or an alkylene group of 1 to 8 carbon atoms (where one or more methylene groups in the alkylene group are each independently optionally replaced with an oxygen atom, —CO—, —COO—, or —OCO—, with the proviso that no oxygen atoms are directly linked to each other, and one or more hydrogen atoms in the alkylene group are each independently optionally replaced with a fluorine atom, a methyl group, or an ethyl group);

A³ and A⁶ are each independently a hydrogen atom, a halogen atom, or an alkyl group of 1 to 10 carbon atoms (where one or more methylene groups in the alkyl group are each independently optionally replaced with an oxygen atom, —CO—, —COO—, or —OCO—, with the proviso that no oxygen atoms are directly linked to each other, and one or more hydrogen atoms in the alkyl group are each independently optionally replaced with a halogen atom or an alkyl group of 1 to 17 carbon atoms);

A⁴ and A⁷ are each independently a hydrogen atom, a halogen atom, or an alkyl group of 1 to 10 carbon atoms (where one or more methylene groups in the alkyl group are each independently optionally replaced with an oxygen atom, —CO—, —COO—, or —OCO—, with the proviso that no oxygen atoms are directly linked to each other, and one or more hydrogen atoms in the alkyl group are each independently optionally replaced with a halogen atom or an alkyl group of 1 to 9 carbon atoms);

p is 1 to 10; and

B¹, B², and B³ are each independently a hydrogen atom or a linear or branched alkyl group of 1 to 10 carbon atoms (where one or more methylene groups in the alkyl group are each independently optionally replaced with an oxygen atom, —CO—, —COO—, or —OCO—, with the proviso that no oxygen atoms are directly linked to each other, and one or more hydrogen atoms in the alkyl group are each independently optionally replaced with a halogen atom or a trialkoxysilyl group of 3 to 6 carbon atoms.)

Other specific polymerizable compounds represented by general formula (VI) include compounds represented by general formula (X1b).

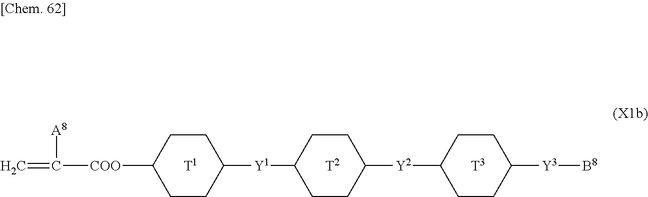

(In the formula,

A⁸ is a hydrogen atom or a methyl group; and

T¹, T², and T³, which are six-membered rings, are each independently any of the following structures (where q is an integer of 1 to 4).)

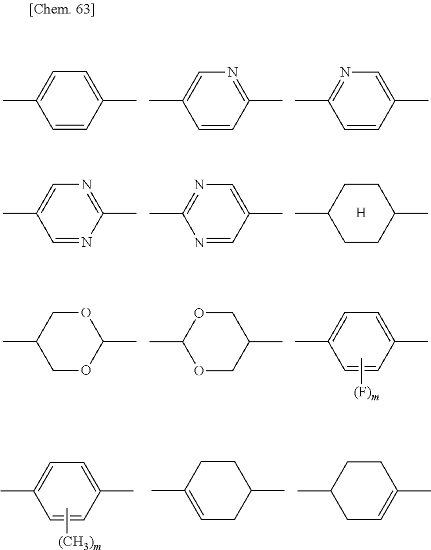

(In general formula (X1b),

q is 0 or 1;

Y¹ and Y² are each independently a single bond, —CH₂CH₂—, —CH₂O—, —OCH₂—, —COO—, —OCO—, —C≡C—, —CH═CH—, —CF═CF—, —(CH₂)₄—, —CH₂CH₂CHO—, —OCH₂CH₂CH₂—, —CH₂═CHCH₂CH₂—, or —CH₂CH₂CH═CH—;

Y³ is a single bond, —COO—, or —OCO—; and

B⁸ is a hydrocarbyl group of 1 to 18 carbon atoms.)

Still other specific polymerizable compounds represented by general formula (VI) include compounds represented by general formula (X1c).

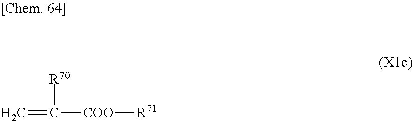

(In the formula, R⁷⁰ is a hydrogen atom or a methyl group, and R⁷⁰ is a hydrocarbyl group having a fused ring.)

Among reactive-group-containing polymerizable compounds, preferred polyfunctional reactive-group-containing polymerizable compounds include polymerizable compounds represented by general formula (VII) below.

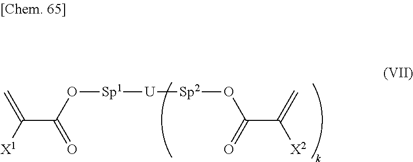

(In the formula, X¹ and X² are each independently a hydrogen atom or a methyl group; Sp¹ and Sp² are each independently a single bond, an alkylene group of 1 to 8 carbon atoms, or —O—(CH₂)ₛ— (where s is an integer of 2 to 7, and the oxygen atom is linked to the aromatic ring); U is a linear or branched polyvalent alkylene group of 2 to 20 carbon atoms or a polyvalent cyclic substituent of 5 to 30 carbon atoms, where the alkylene group in the polyvalent alkylene group is optionally substituted with an oxygen atom, with the proviso that no oxygen atoms are adjacent to each other, and is optionally substituted with an alkyl group of 5 to 20 carbon atoms (where the alkylene group in the group is optionally substituted with an oxygen atom, with the proviso that no oxygen atoms are adjacent to each other) or a cyclic substituent; and k is an integer of 1 to 5.)

Although X¹ and X² in general formula (VII) above are each independently a hydrogen atom or a methyl group, a hydrogen atom is preferred if a higher reaction rate is desired, whereas a methyl group is preferred if a lower residual monomer content is desired.

Although Sp¹ and Sp² in general formula (VII) above are each independently a single bond, an alkylene group of 1 to 8 carbon atoms, or —O—(CH₂)ₛ— (where s is an integer of 2 to 7, and the oxygen atom is linked to the aromatic ring), shorter carbon chains are preferred. Specifically, Sp¹ and Sp² are preferably a single bond or an alkylene group of 1 to 5 carbon atoms, more preferably a single bond or an alkylene group of 1 to 3 carbon atoms. If Sp¹ or Sp² is —O—(CH₂)ₛ—, s is preferably 1 to 5, more preferably 1 to 3. More preferably, at least one of Sp¹ and Sp² is a single bond, and even more preferably, both of them are single bonds.

Although U in general formula (VII) above is a linear or branched polyvalent alkylene group of 2 to 20 carbon atoms or a polyvalent cyclic substituent of 5 to 30 carbon atoms, the alkylene group in the polyvalent alkylene group may be substituted with an oxygen atom, with the proviso that no oxygen atoms are adjacent to each other, and may be substituted with an alkyl group of 5 to 20 carbon atoms (where the alkylene group in the group is optionally substituted with an oxygen atom, with the proviso that no oxygen atoms are adjacent to each other) or a cyclic substituent, preferably with two or more cyclic substituents.

Specifically, U in general formula (VII) above is preferably represented by any of formulas (VII-1) to (VII-5) below, more preferably any of formulas (VII-1) to (VII-3), even more preferably formula (VII-1).

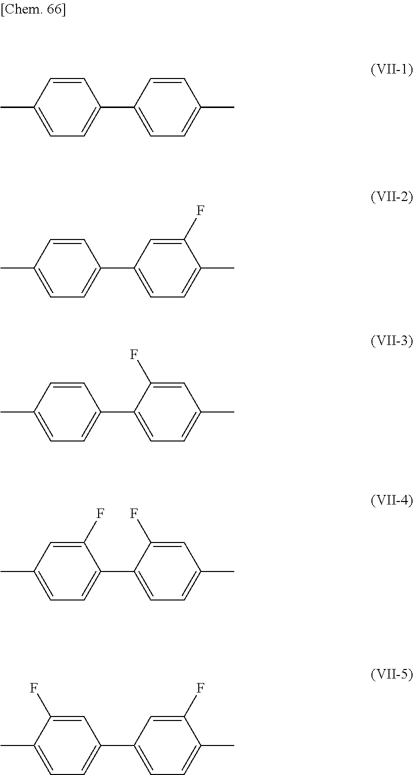

(In the formulas, each end is linked to Sp¹ or Sp².)

If U has a ring structure, it is preferred that at least one of Sp¹ and Sp² be a single bond, and it is also preferred that both of them be single bonds.

Although k in general formula (VII) above is an integer of 1 to 5, difunctional compounds, where k is 1, and trifunctional compounds, where k is 2, are preferred. More preferred are difunctional compounds.

More specifically, the liquid crystal composition according to the present invention preferably contains one or more polymerizable compounds represented by general formula (M).

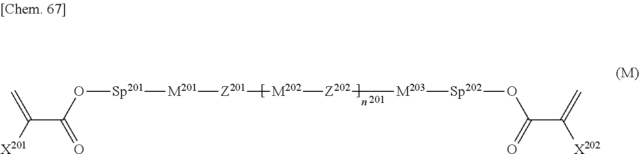

In general formula (M), X²⁰¹ and X²⁰² are each independently a hydrogen atom, a methyl group, or a —CF₃ group. Diacrylate derivatives, where both X²⁰¹ and X²⁰² are hydrogen atoms, and dimethacrylate derivatives, where both X²⁰¹ and X²⁰² are methyl groups, are preferred. Also preferred are compounds where one of X²⁰¹ and X²⁰² is a hydrogen atom and the other is a methyl group. Although any preferred compound may be used depending on the application, it is preferred to use at least one dimethacrylate derivative as the polymerizable compounds represented by general formula (M) for PSA display devices, and it is also preferred to use two dimethacrylate derivatives.

In general formula (M), Sp²⁰¹ and Sp²⁰² are each independently a single bond, an alkylene group of 1 to 8 carbon atoms, or —O—(CH₂)ₛ— (where s is an integer of 2 to 7, and the oxygen atom is linked to the ring). Compounds where at least one of Sp²⁰¹ and Sp²⁰² is a single bond, including those where both of Sp²⁰¹ and Sp²⁰² are single bonds and those where one of Sp²⁰¹ and Sp²⁰² is a single bond and the other is an alkylene group of 1 to 8 carbon atoms or —O—(CH₂)ₛ—, are preferred for PSA liquid crystal display devices. In this case, an alkylene group of 1 to 4 carbon atoms is preferred, and s is preferably 1 to 4.

In general formula (M), M²⁰¹, M²⁰², and M²⁰³ are each independently trans-1,4-cyclohexylene (where one or more non-adjacent —CH₂— groups in the group are optionally replaced with —O— or —S—), 1,4-phenylene (where one or more non-adjacent —CH═ groups in the group are optionally replaced with —N═), 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl, where the hydrogen atoms in the groups are each independently optionally replaced with a fluorine atom, a —CF₃ group, an alkyl group of 1 to 10 carbon atoms, an alkoxyl group of 1 to 10 carbon atoms, or any of formulas (R-1) to (R-15).

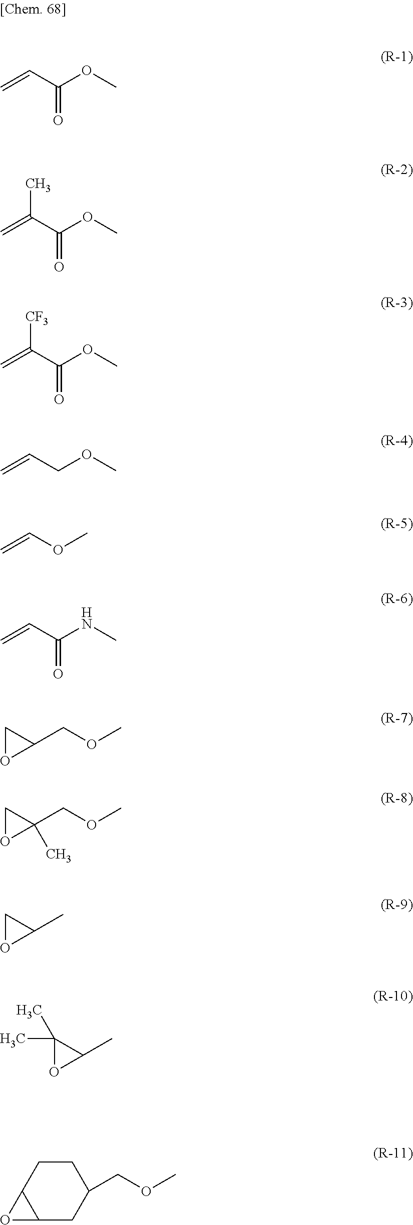

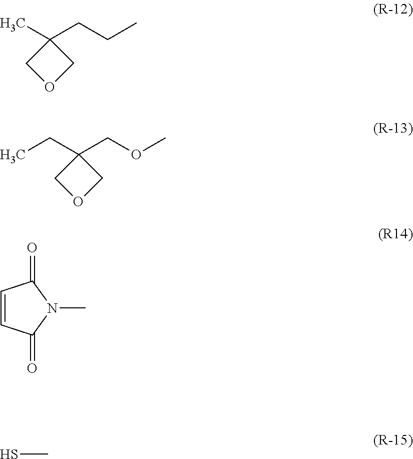

In general formula (M), Z^{20′} and Z²⁰² are each independently —OCH₂—, —CH₂O—, —COO—, —OCO—, —CF₂O—, —OCF₂—, —CH₂CH—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (where Y¹ and Y² are each independently a fluorine or hydrogen atom), —C≡C—, or a single bond, preferably —COO—, —OCO—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —C≡C—, or a single bond, more preferably —COO—, —OCO—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, or a single bond.

In general formula (M), n²⁰¹ is 0, 1, or 2, preferably 0 or 1, where each occurrence of M²⁰² and Z²⁰² may be the same or different.

The liquid crystal composition according to the present invention may contain at least one polymerizable compound represented by general formula (M), preferably one to five polymerizable compounds represented by general formula (M), more preferably one to three polymerizable compounds represented by general formula (M).

The polymerizable compounds represented by general formula (M) are preferably present in an amount of 0.01% to 2.00% by mass, more preferably 0.05% to 1.00% by mass, even more preferably 0.10% to 0.50% by mass.

More specifically, if n²⁰¹ in general formula (M) is 0, the ring structure between Sp²⁰¹ and Sp²⁰² is preferably represented by any of formulas (XXa-1) to (XXa-5), more preferably any of formulas (XXa-1) to (XXa-3), even more preferably formula (XXa-1) or (XXa-2). In the formulas, each end is linked to Sp²⁰¹ or Sp²⁰².

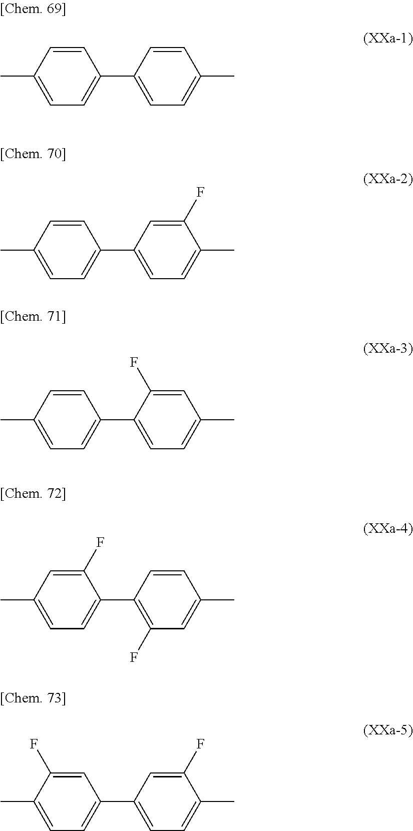

Polymerizable compounds represented by general formula (M) that contain these backbones produce an anchoring force suitable for PSA liquid crystal display devices after polymerization, which contributes to good alignment. These compounds are therefore effective in reducing or eliminating uneven display.

Thus, preferred polymerizable monomers include compounds represented by formulas (XX-1) to (XX-10), more preferably formulas (XX-1) to (XX-4).

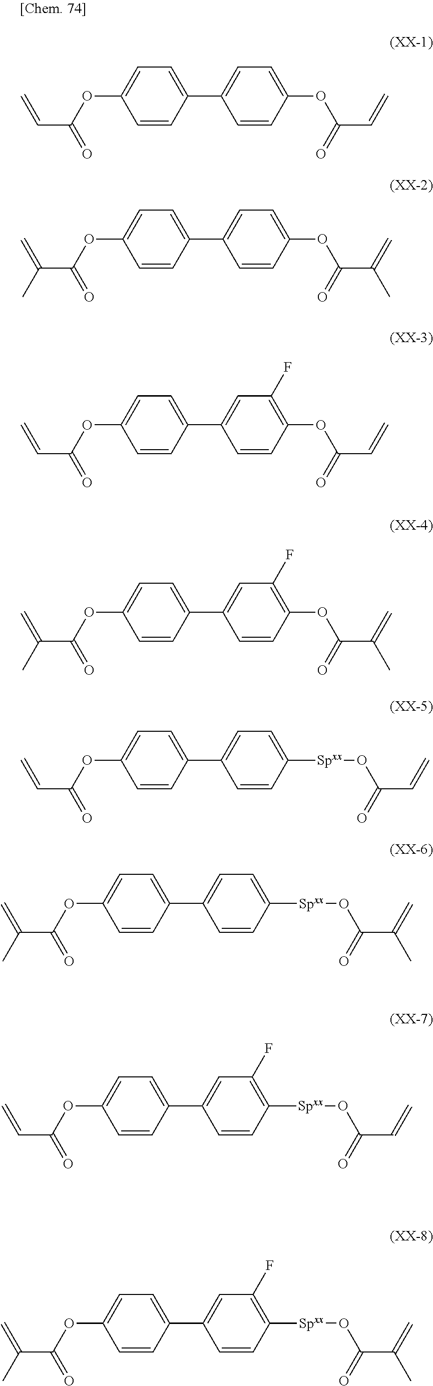

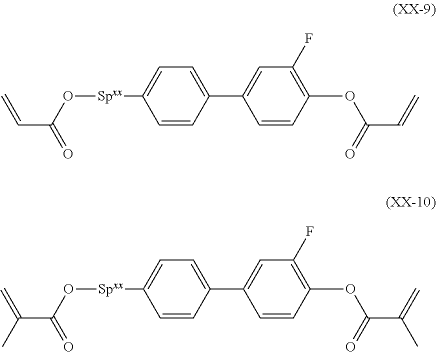

In formulas (XX-1) to (XX-10), Sp^{xx} is an alkylene group of 1 to 8 carbon atoms or —O—(CH₂)ₛ— (where s is an integer of 2 to 7, and the oxygen atom is linked to the ring).

In formulas (XX-1) to (XX-10), the hydrogen atoms in the 1,4-phenylene groups are optionally replaced with —F, —Cl, —CF₃, —CH₃, or any of formulas (R-1) to (R-15).

Examples of preferred polymerizable compounds represented by general formula (M) where n²⁰¹ is 1 include polymerizable compounds represented by formulas (M31) to (M48).

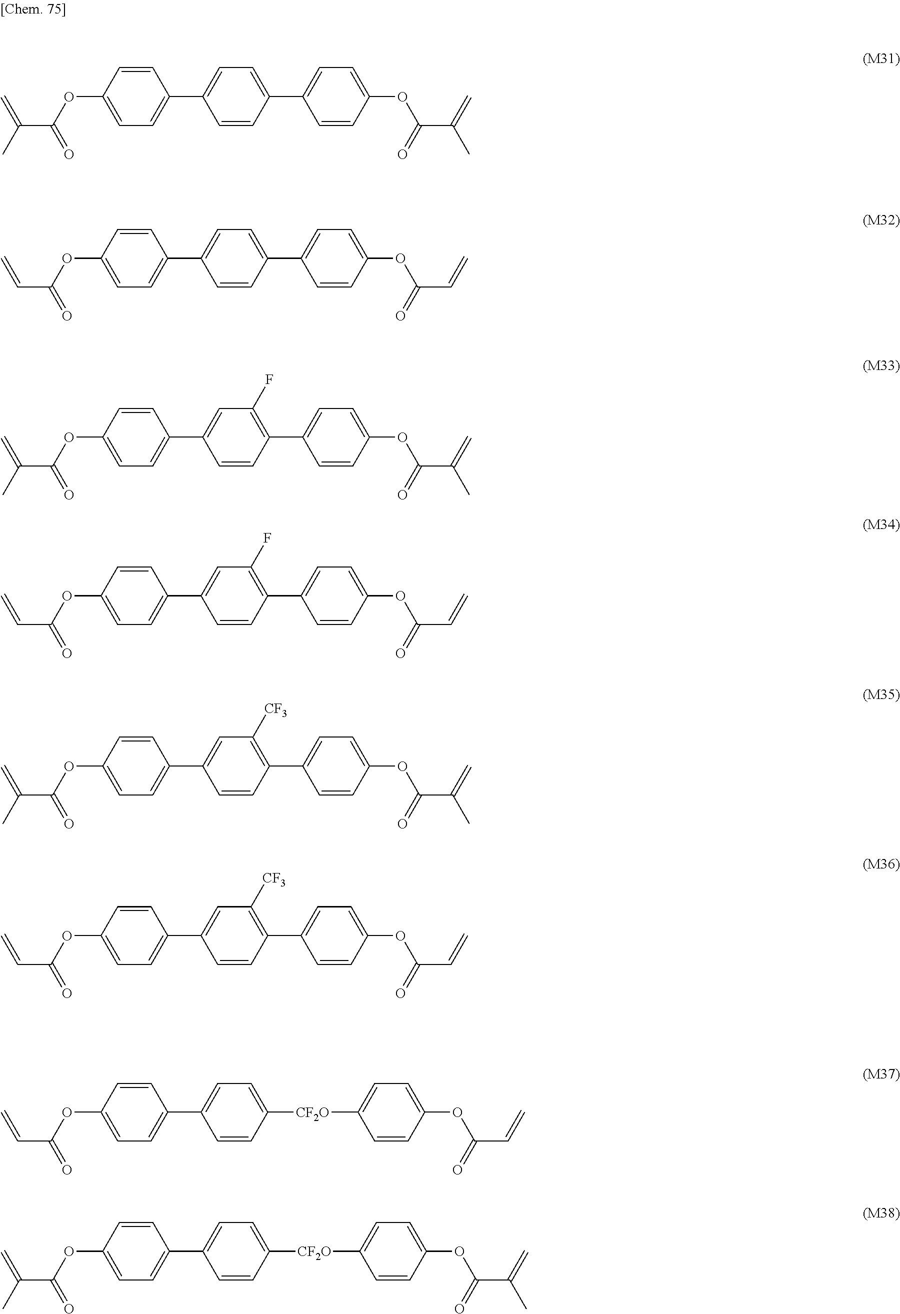

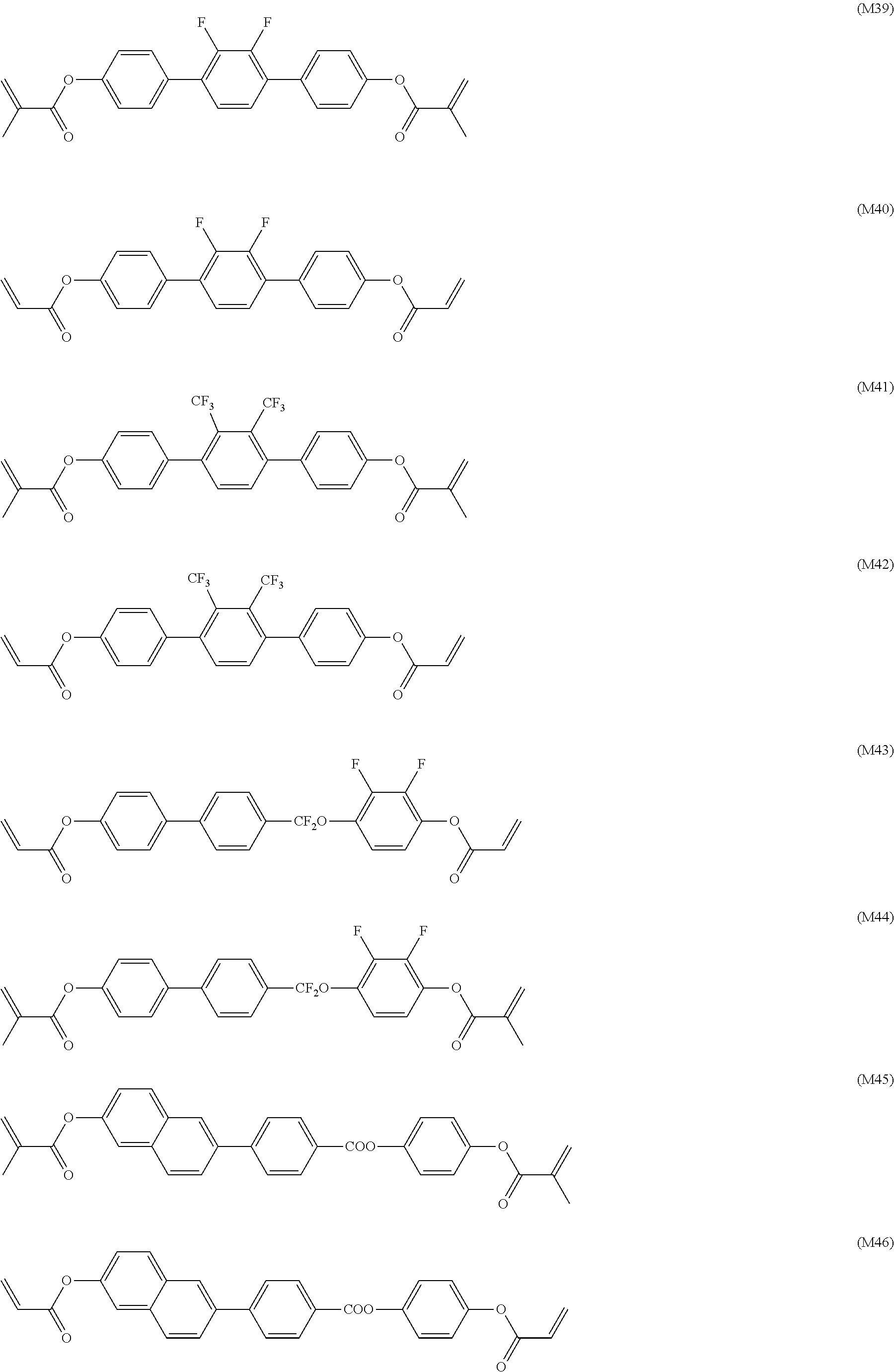

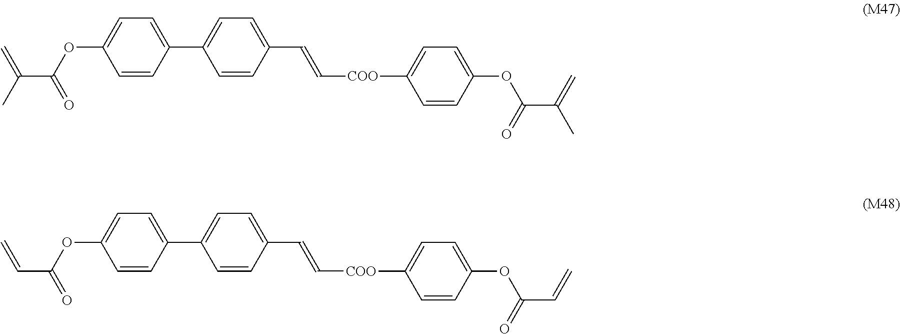

In formulas (M31) to (M48), the hydrogen atoms in the 1,4-phenylene and naphthalene groups are optionally replaced with —F, —Cl, —CF₃, —CH₃, or any of formulas (R-1) to (R-15).

Polymerizable compounds represented by general formula (M) that contain these backbones produce an anchoring force suitable for PSA liquid crystal display devices after polymerization, which contributes to good alignment. These compounds are therefore effective in reducing or eliminating uneven display.

Examples of preferred polymerizable compounds represented by general formula (M) where n²⁰¹ is 1 and containing a plurality of groups represented by formula (R-1) or (R-2) include polymerizable compounds represented by formulas (M301) to (M316).

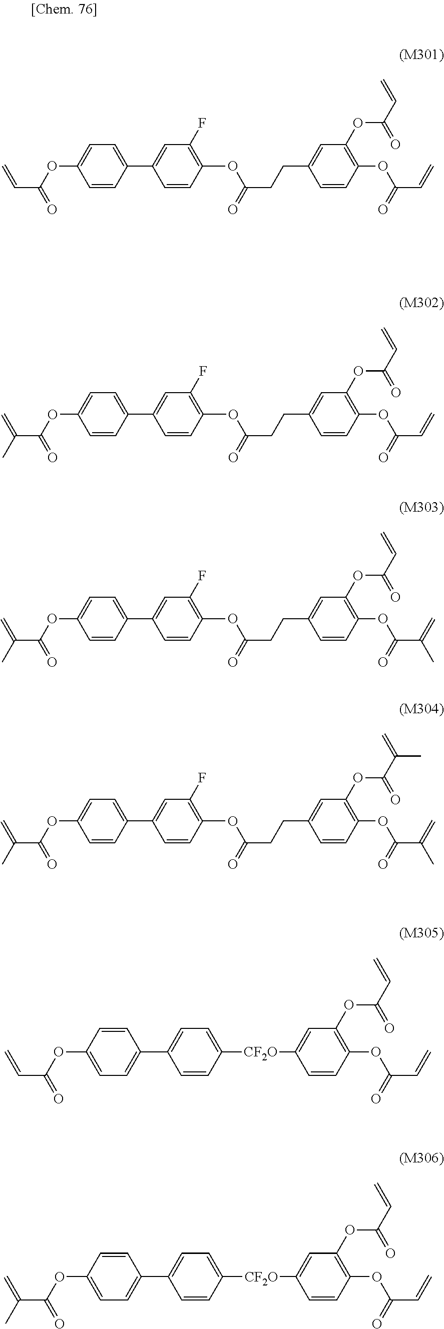

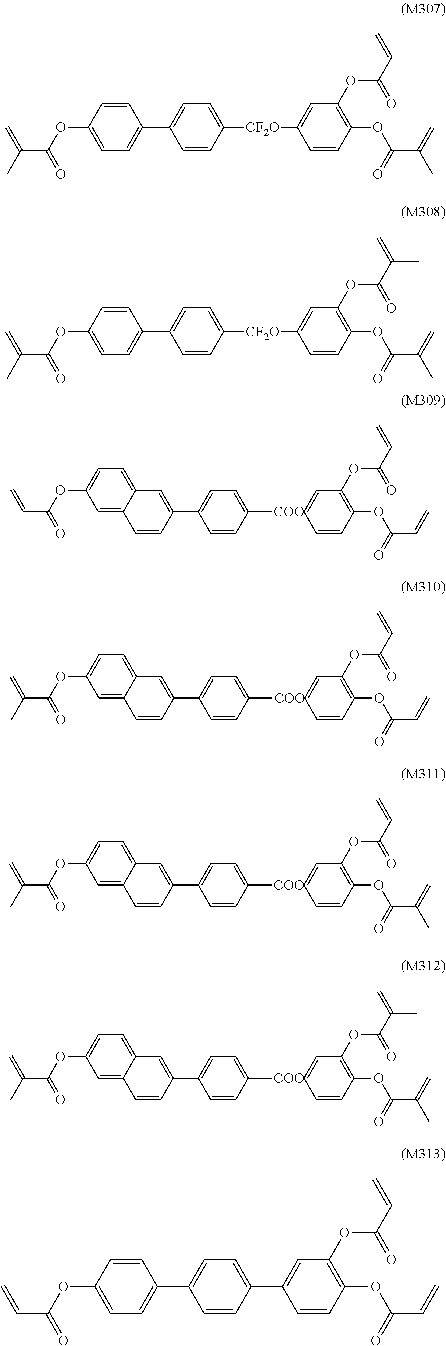

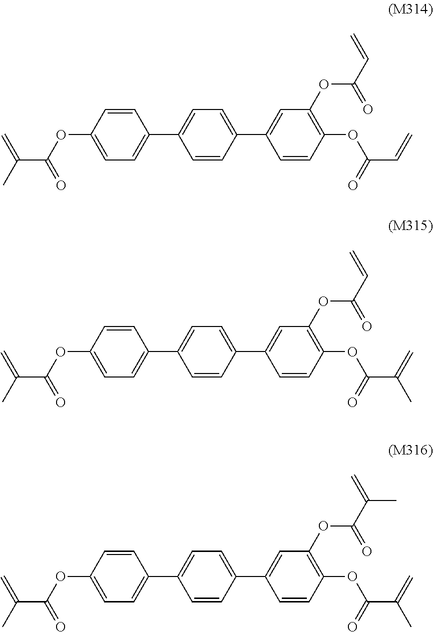

In formulas (M301) to (M316), the hydrogen atoms in the 1,4-phenylene and naphthalene groups are optionally replaced with —F, —Cl, —CF₃, or —CH₃.

Other examples of preferred polymerizable compounds represented by general formula (M) include polymerizable compounds represented by formulas (Ia-1) to (Ia-31).

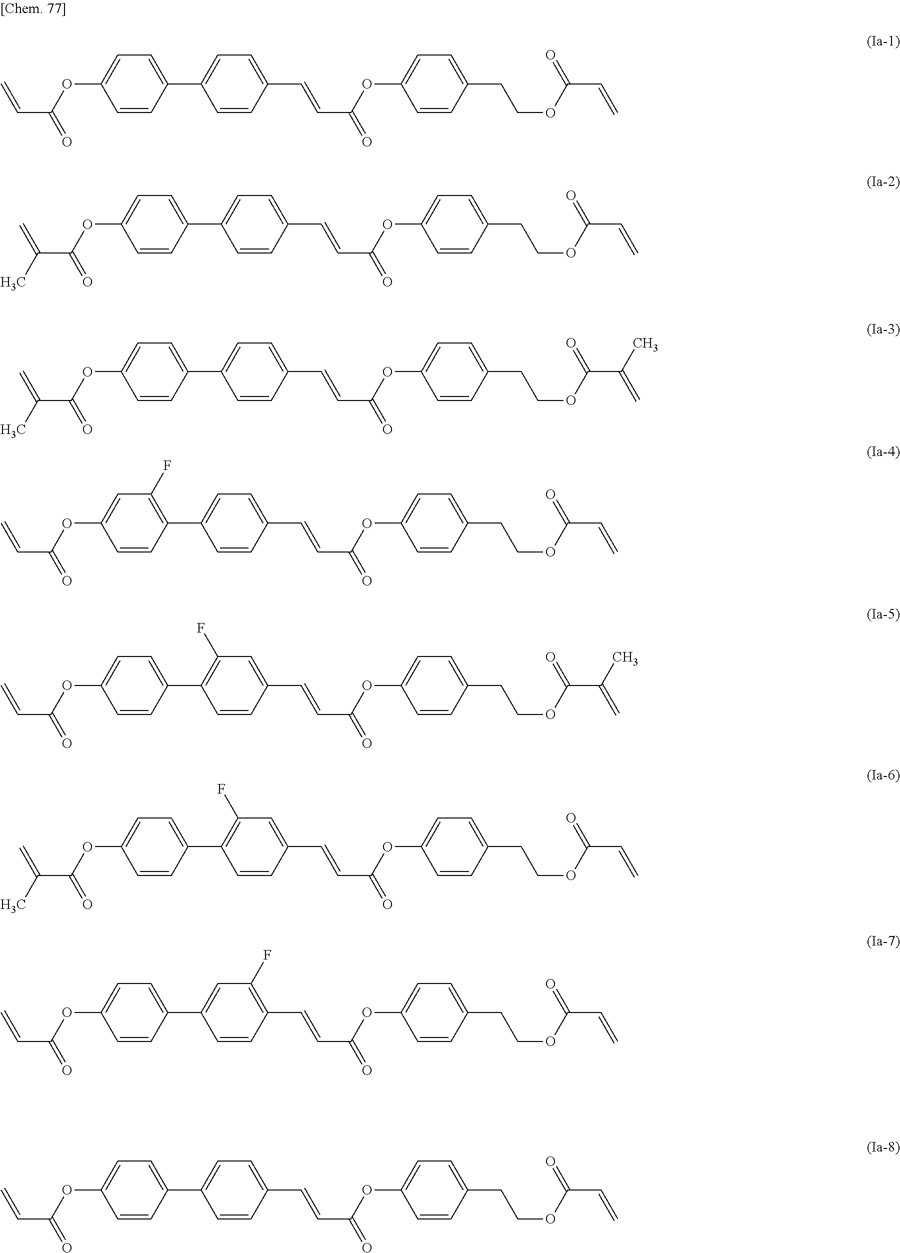

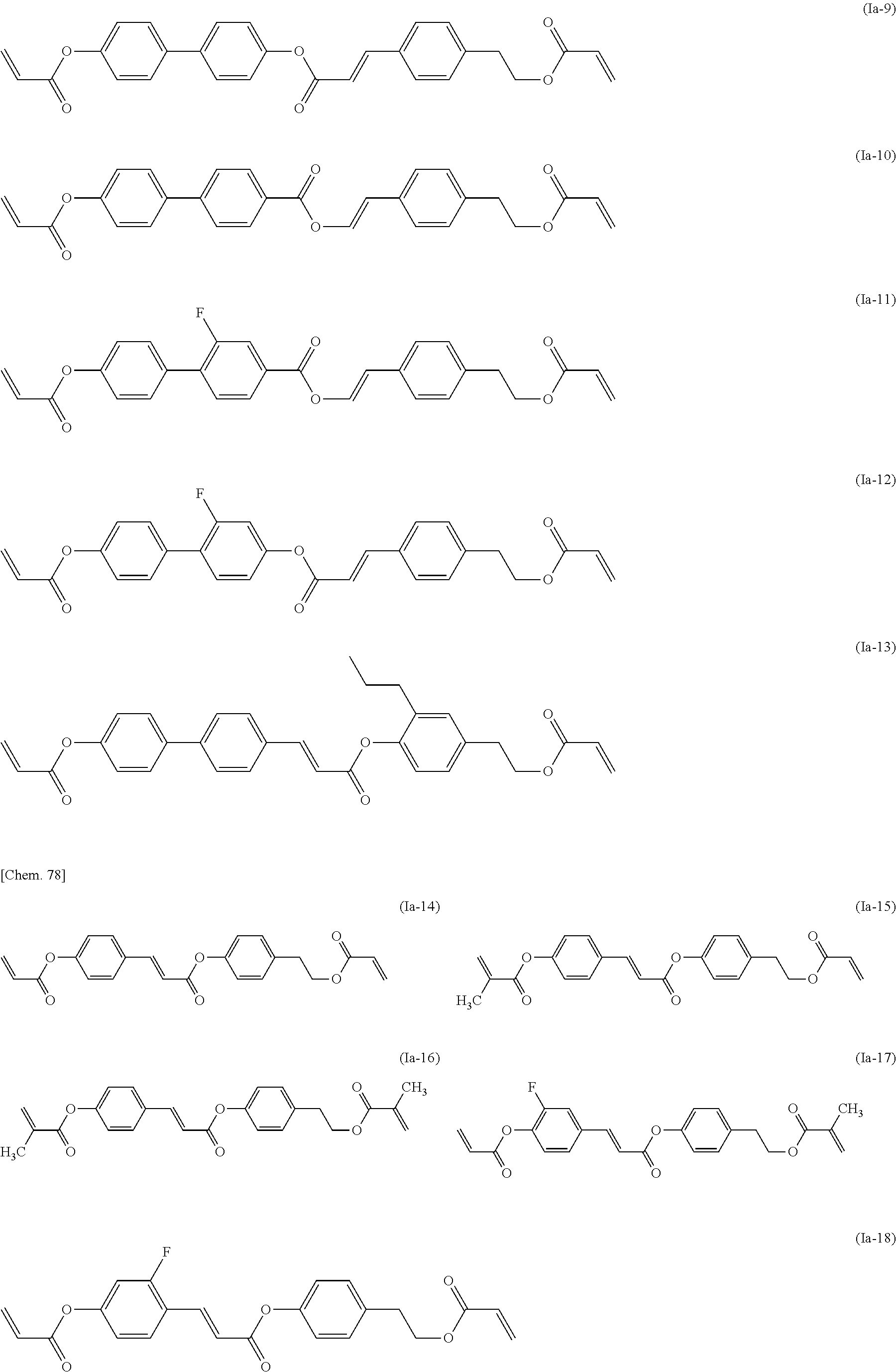

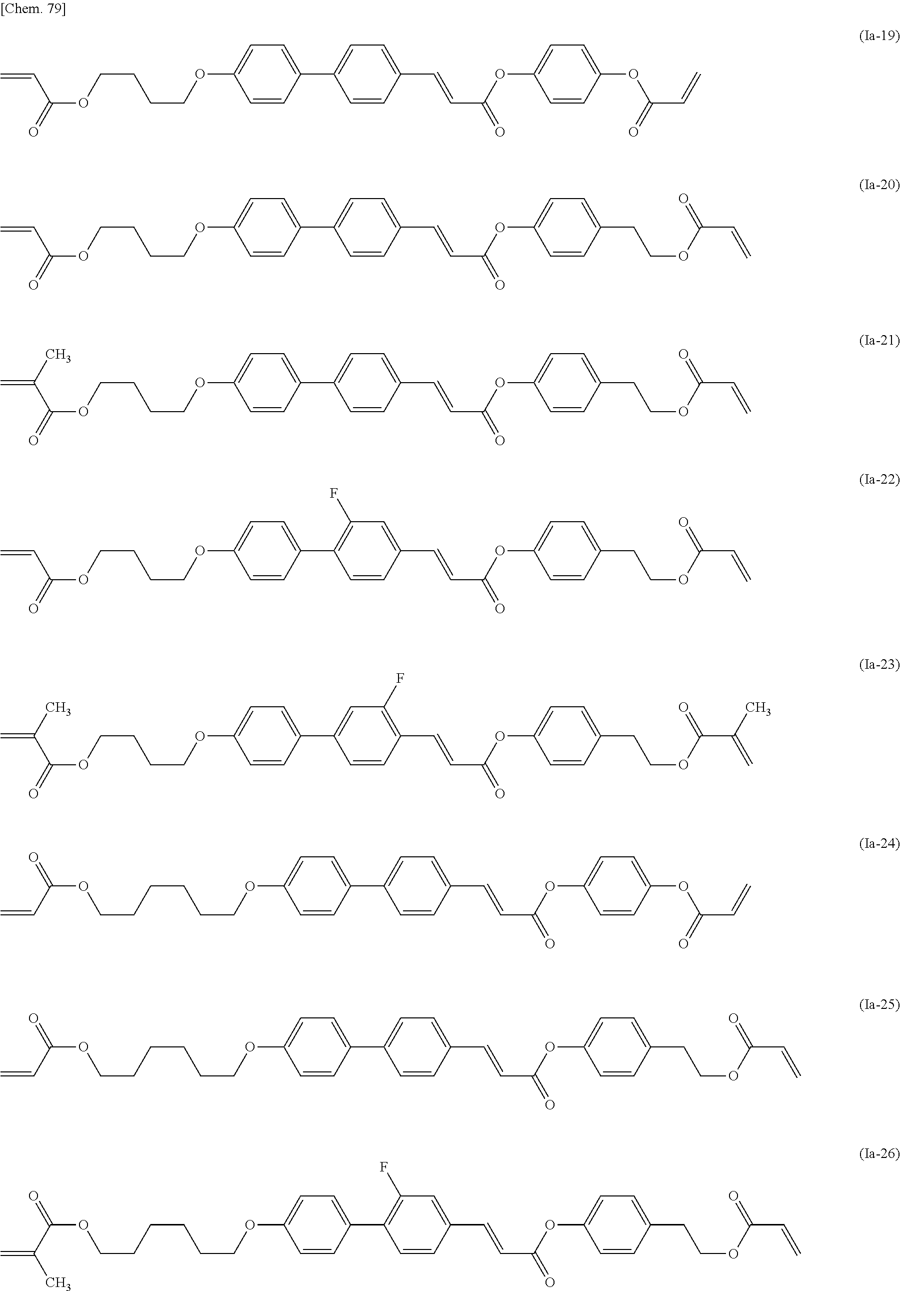

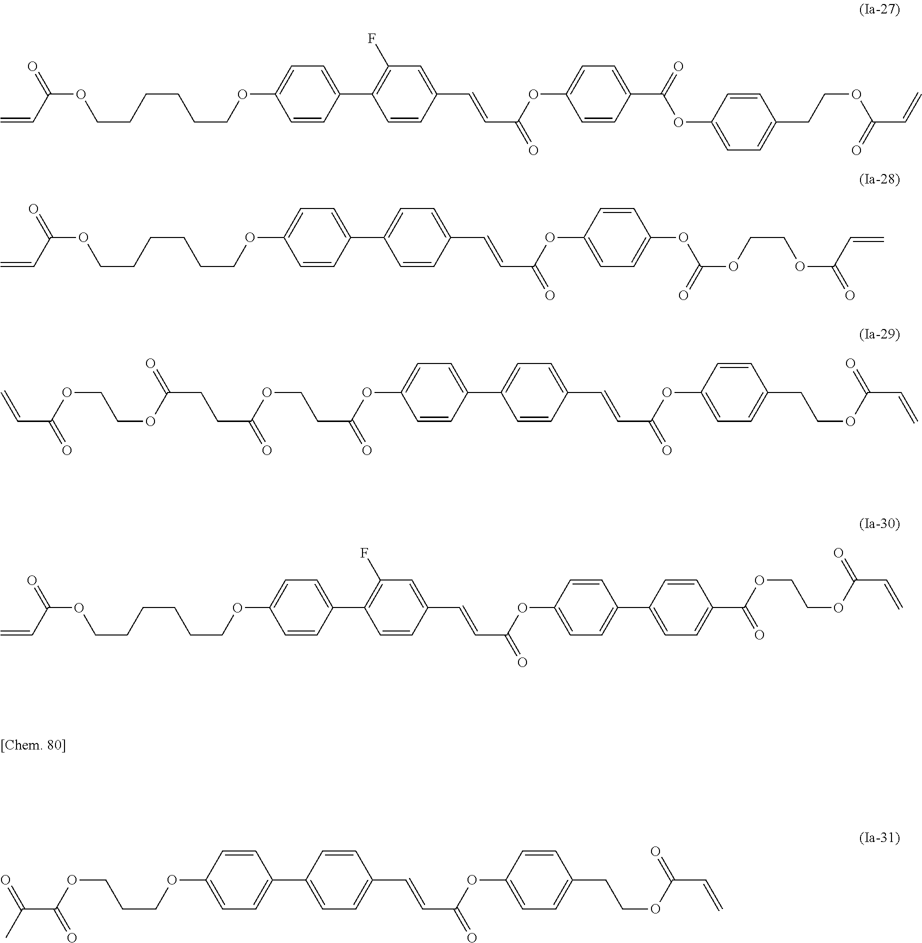

Preferred antioxidants include hindered phenols represented by general formulas (H-1) to (H-4).

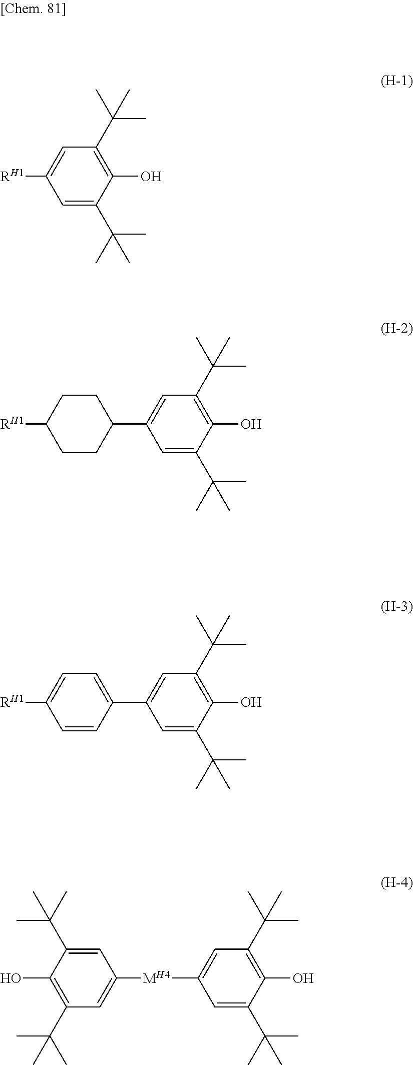

In general formulas (H-1) to (H-4), R^{H1} is an alkyl group of 1 to 10 carbon atoms, an alkoxyl group of 1 to 10 carbon atoms, an alkenyl group of 2 to 10 carbon atoms, or an alkenyloxy group of 2 to 10 carbon atoms, where one or more non-adjacent —CH₂— groups present in the groups are each independently optionally replaced with —O— or —S—, and one or more hydrogen atoms present in the groups are each independently optionally replaced with a fluorine or chlorine atom. More specifically, R^{H1} is preferably an alkyl group of 2 to 7 carbon atoms, an alkoxyl group of 2 to 7 carbon atoms, an alkenyl group of 2 to 7 carbon atoms, or an alkenyloxy group of 2 to 7 carbon atoms, more preferably an alkyl group of 3 to 7 carbon atoms or an alkenyl group of 2 to 7 carbon atoms.

In general formula (H-4), M^{H4} is an alkylene group of 1 to 15 carbon atoms (where one or more —CH₂— groups present in the alkylene group are optionally replaced with —O—, —CO—, —COO—, or —OCO—, with the proviso that no oxygen atoms are directly adjacent to each other), —OCH₂—, —CH₂O—, —COO—, —OCO—, —CF₂O—, —OCF₂—, —CF₂CF₂—, —CH═CH—COO—, —CH═CH—OCO—, —COO—CH═CH—, —OCO—CH═CH—, —CH═CH—, —C≡C—, a single bond, 1,4-phenylene (where any hydrogen atom present in the 1,4-phenylene group is optionally replaced with a fluorine atom), or trans-1,4-cyclohexylene. Preferably, M^{H4} is an alkylene group of 1 to 14 carbon atoms, more preferably 2 to 12 carbon atoms, even more preferably 3 to 10 carbon atoms, still more preferably 4 to 10 carbon atoms, yet more preferably 5 to 10 carbon atoms, further preferably 6 to 10 carbon atoms. A larger number of carbon atoms are preferred for reasons of volatility, whereas a moderate number of carbon atoms are preferred for reasons of viscosity.

In general formulas (H-1) to (H-4), one or more non-adjacent —CH═ groups in the 1,4-phenylene group are optionally replaced with —N═, and the hydrogen atoms in the 1,4-phenylene group are each independently optionally replaced with a fluorine or chlorine atom.

In general formulas (H-1) to (H-4), one or more non-adjacent —CH₂— groups in the 1,4-cyclohexylene group are optionally replaced with —O— or —S—, and the hydrogen atoms in the 1,4-cyclohexylene group are each independently optionally replaced with a fluorine or chlorine atom.

Specific examples include hindered phenols represented by formulas (H-11) to (H-15).

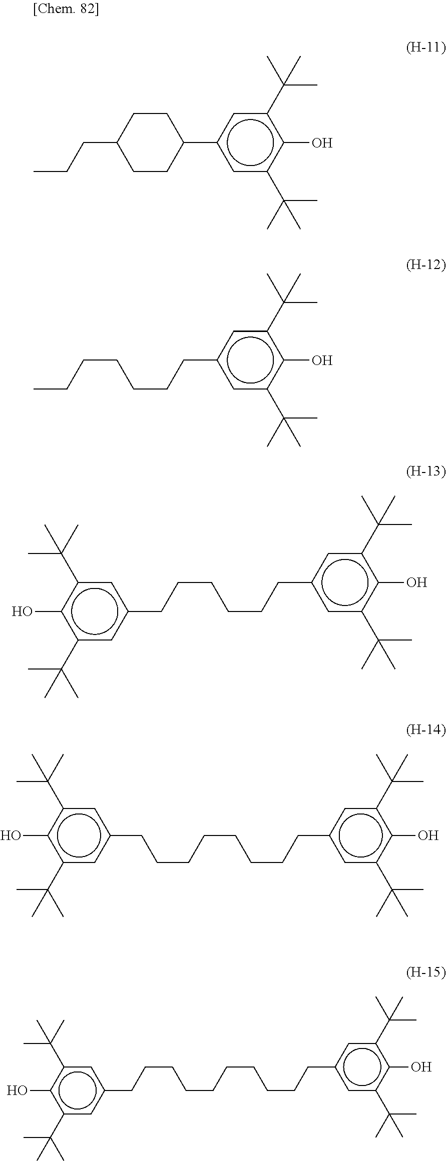

These antioxidants may be present in the liquid crystal composition according to the present invention in an amount of 1 ppm by mass or more, preferably 10 ppm by mass or more, more preferably 20 ppm by mass or more, even more preferably 50 ppm by mass or more. The upper limit of the amount of antioxidant present in the liquid crystal composition is 10,000 ppm by mass, preferably 1,000 ppm by mass, more preferably 500 ppm by mass, even more preferably 100 ppm by mass.

A liquid crystal display device including the liquid crystal composition according to the present invention has fast response time and good display quality with reduced or no display defects. In particular, the liquid crystal composition according to the present invention can be used for active-matrix liquid crystal display devices such as VA, PSVA, PSA, FFS, IPS, and ECB display devices. It should be noted that PSVA and PSA are practically synonymous.

### EXAMPLES

The present invention is further illustrated by the following examples, although these examples are not intended to limit the invention. The percentages in the compositions of the following Examples and Comparative Examples are by mass.

The compounds used in the examples are designated by the following abbreviations:

### Side Chains

-n -CₙH₂ₙ₊₁ linear alkyl group of n carbon atoms
n- CₙH₂ₙ₊₁- linear alkyl group of n carbon atoms
-On -OCₙH₂ₙ₊₁ linear alkoxyl group of n carbon atoms
nO— CₙH₂ₙ₊₁O— linear alkoxyl group of n carbon atoms
—V —CH═CH₂
V— CH₂═CH—
—V1 —CH═CH—CH₃
1V— CH₃—CH═CH—
-2V —CH₂—CH₂—CH═CH₂
V2- CH₂═CH—CH₂—CH₂—
-2V1 —CH₂—CH₂—CH═CH—CH₃
1V2- CH₃—CH═CH—CH₂—CH₂—

### Linking Groups

—CF2O— —CF₂—O—
—OCF2- —O—CF₂—
-1O— —CH₂—O—
—O1— —O—CH₂—
—COO— —COO—
—OCO— —OCO—

### Ring Structures

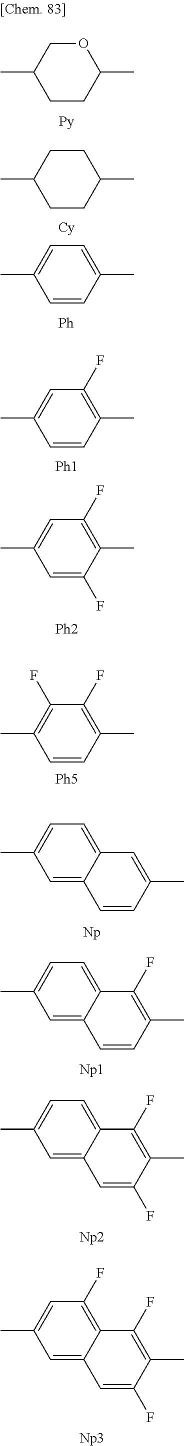

The properties measured in the examples are as follows.

Tₙᵢ: nematic-isotropic liquid phase transition temperature (° C.)

Δn: refractive index anisotropy at 20° C.

Δ∈: dielectric anisotropy at 25° C.

η: viscosity (mPa·s) at 20° C.

γ₁: rotational viscosity (mPa·s) at 20° C.

K₃₃: elastic constant K₃₃ (pN) at 20° C.

VHR(UV): voltage holding ratio (1 V, 60 Hz, 60° C.) after UV exposure (150 J) with high-pressure mercury lamp (intensity: 100 mW/cm² at 365 nm)

### Comparative Example 1, Example 1, Example 2, Example 3, and Example 4

Liquid crystal compositions denoted as LC-1 (Example 1), LC-2 (Example 2), LC-3 (Example 3), and LC-4 (Example 4) were prepared by adding the compound represented by general formula (I-28H) or (I-32H) to LC-A (Comparative Example 1) and were tested for their physical properties. Table 1 summarizes the components and physical properties of the liquid crystal compositions.

TABLE 1

| | | Comparative | | | | |
|---|---|---|---|---|---|---|
| | | Example 1 | Example 1 | Example 2 | Example 3 | Example 4 |
| | | LC-A | LC-1 | LC-2 | LC-3 | LC-4 |
| 3-Ph-Ph-1 | general formula (III-F) | 5 | — | — | — | — |
| 3-Cy-Cy-V | general formula (I-V) | 39 | — | — | — | — |
| Compound of formula | general formula (I-I) | — | 0.05 | 0.1 | 0.2 | — |
| (I-28H) | | | | | | |
| Compound of formula | general formula (I-I) | — | — | — | — | 0.2 |
| (I-32H) | | | | | | |
| 3-Cy-1O-Ph5-O2 | general formula (II-1A-1) | 9 | — | — | — | — |
| 2-Cy-Cy-1O-Ph5-O2 | general formula (II-1B-1) | 13 | — | — | — | — |
| 3-Cy-Cy-1O-Ph5-O2 | general formula (II-1B-1) | 13 | — | — | — | — |
| 4-Cy-Cy-1O-Ph5-O2 | general formula (II-1B-1) | 3 | — | — | — | — |
| 3-Ph-Ph5-Ph-1 | general formula (LC3-b1) | 9 | — | — | — | — |
| 3-Ph-Ph5-Ph-2 | general formula (LC3-b1) | 9 | — | — | — | — |
| Composition LC-A | | — | 99.95 | 99.9 | 99.8 | 99.8 |
| Total | | 100 | 100 | 100 | 100 | 100 |
| Tni [° C.] | | 74.2 | 74.1 | 74.1 | 74.0 | 74.0 |
| Δn | | 0.108 | 0.108 | 0.108 | 0.108 | 0.108 |
| η [mPa · s] | | 13.8 | 13.8 | 13.8 | 13.8 | 13.8 |
| γ1 [mPa · s] | | 96 | 96 | 96 | 96 | 96 |
| Δε | | −3.2 | −3.2 | −3.2 | −3.2 | −3.2 |
| K33 [pN] | | 14.3 | 14.3 | 14.3 | 14.3 | 14.3 |
| γ1/K33 | | 6.7 | 6.7 | 6.7 | 6.7 | 6.7 |
| VHR (UV) | | 72 | 88 | 90 | 89 | 98 |

LC-1, LC-2, LC-3, and LC-4, which are liquid crystal compositions according to the present invention, were found to have low viscosities (η), low rotational viscosities (γ₁), high K₃₃, and sufficiently higher VHR(UV) than LC-A, which is a comparative example. In particular, LC-4 was found to have a significantly high VHR(UV). It was also found that these liquid crystal compositions did not cause uneven display.

Response time measurements on liquid crystal display devices fabricated using these liquid crystal compositions showed that they had sufficiently fast response times for television applications. The cell thickness was 3.5 μm, and the alignment layers were JALS 2096. The response time was measured at a Von of 6 V, a Voff of 1 V, and a measurement temperature of 25° C. using an Autronic-Melchers DMS 703.

A PSVA liquid crystal display device was also fabricated using a liquid crystal composition containing 99.6% by mass of LC-2 and 0.4% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.6% by mass of LC-2 and 0.4% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.7% by mass of LC-2 and 0.3% of the polymerizable monomer represented by formula (XX-4) to which 20 ppm of the antioxidant represented by formula (H-14) was added. It was found that this liquid crystal display device did not exhibit display defects and had a sufficiently fast response time.

A PSVA liquid crystal display device was also fabricated using a liquid crystal composition containing 99.6% by mass of LC-4 and 0.4% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-4, 0.4% by mass of the polymerizable monomer represented by formula (XX-4), and 0.1% by mass of the polymerizable monomer represented by formula (Ia-31). It was found that this liquid crystal display device did not exhibit display defects and had a sufficiently fast response time.

A PSVA liquid crystal display device was also fabricated using a liquid crystal composition containing 99.7% by mass of LC-4 and 0.3% by mass of the polymerizable monomer represented by formula (XX-4) to which 20 ppm of the antioxidant represented by formula (H-12) was added. It was found that this liquid crystal display device did not exhibit display defects and had a sufficiently fast response time.

### Comparative Example 2, Example 5, Example 6, Example 7, and Example 8

Liquid crystal compositions denoted as LC-B (Comparative Example 2), LC-5 (Example 5), LC-6 (Example 6), LC-7 (Example 7), and LC-8 (Example 8) were prepared and tested for their physical properties. Table 2 summarizes the components and physical properties of the liquid crystal compositions.

TABLE 2

| | | Comparative | | | | |
|---|---|---|---|---|---|---|
| | | Example 2 | Example 5 | Example 6 | Example 7 | Example 8 |
| | | LC-B | LC-5 | LC-6 | LC-7 | LC-8 |
| 3-Ph-Ph-1 | general formula (III-F) | 9 | — | — | — | — |
| 3-Cy-Cy-2 | general formula (III-A) | 4 | — | — | — | — |
| 3-Cy-Cy-V | general formula (I-V) | 30 | — | — | — | — |
| 3-Cy-Cy-V1 | general formula (I-V1) | 4 | — | — | — | — |
| Compound of formula | general formula (I-1) | — | 0.03 | 0.07 | — | — |
| (I-28H) | | | | | | |
| Compound of formula | general formula (I-1) | — | — | — | 0.15 | 0.3 |
| (I-32H) | | | | | | |
| V-Cy-Ph-Ph-3 | general formula (III-H) | 7 | — | — | — | — |
| 3-Cy-Ph-Ph-2 | general formula (III-H) | 3 | — | — | — | — |
| 3-Cy-1O-Ph5-O2 | general formula (II-1A-1) | 5 | — | — | — | — |
| 1V-Cy-1O-Ph5-O1 | general formula (II-IA-1) | 5 | — | — | — | — |
| IV-Cy-1O-Ph5-O2 | general formula (II-1A-1) | 5 | — | — | — | — |
| 3-Cy-Cy-1O-Ph5-O2 | general formula (II-1B-1) | 13 | — | — | — | — |
| 1V-Cy-Cy-1O-Ph5-O1 | general formula (II-1B-1) | 7 | — | — | — | — |
| 1V-Cy-Cy-1O-Ph5-O2 | general formula (II-1B-1) | 7 | — | — | — | — |
| 3-Np-Ph5-Ph-2 | general formula (LC3-b11) | 1 | — | — | — | — |
| Composition LC-B | | — | 99.97 | 99.93 | 99.85 | 99.7 |
| Total | | 100 | 100 | 100 | 0.15 | 0.3 |
| Tni [° C.] | | 73 | 73 | 73 | 73 | 73 |
| Δn | | 0.097 | 0.097 | 0.097 | 0.097 | 0.097 |
| η [mP · s] | | 13.3 | 13.3 | 13.3 | 13.3 | 13.3 |
| γ1 [mPa · s] | | 75 | 75 | 75 | 75 | 75 |
| Δε | | −2.8 | −2.8 | −2.8 | −2.8 | −2.8 |
| K33 [pN] | | 15.3 | 15.3 | 15.3 | 15.3 | 15.3 |
| γ1/K33 | | 4.9 | 4.9 | 4.9 | 4.9 | 4.9 |
| VHR (UV) | | 60 | 81 | 89 | 90 | 91 |

LC-5, LC-6, LC-7, and LC-8, which are liquid crystal compositions according to the present invention, were found to have low viscosities (i), low rotational viscosities (γ₁), high K₃₃, and significantly higher VHR(UV) than LC-B, which is a comparative example. Among these, LC-7 and LC-8 were found to have particularly high VHR(UV). It was also found that these liquid crystal compositions did not cause uneven display.

Response time measurements on liquid crystal display devices fabricated using these liquid crystal compositions showed that they had sufficiently fast response times for television applications. The cell thickness was 3.5 μm, and the alignment layers were JALS 2096. The response time was measured at a Von of 6 V, a Voff of 1 V, and a measurement temperature of 25° C. using an Autronic-Melchers DMS 703.

A PSVA liquid crystal display device was also fabricated using a liquid crystal composition containing 99.6% by mass of LC-5 and 0.4% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.6% by mass of LC-7 and 0.4% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.7% by mass of LC-5 and 0.3% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-7, 0.3% by mass of the polymerizable monomer represented by formula (XX-4), and 0.1% by mass of the polymerizable monomer represented by formula (Ia-31). It was found that this liquid crystal display device did not exhibit display defects and had a sufficiently fast response time.

### Comparative Example 3, Example 9, and Example 10

Liquid crystal compositions denoted as LC-C (Comparative Example 3), LC-9 (Example 9), and LC-10 (Example 10) were prepared and tested for their physical properties. Table 3 summarizes the components and physical properties of the liquid crystal compositions.

TABLE 3

| | | Comparative | | |
|---|---|---|---|---|
| | | Example 3 | Example 9 | Example 10 |
| | | LC-C | LC-9 | LC-10 |
| 3-Cy-Cy-V | general formula (I-V) | 20 | — | — |
| 3-Cy-Cy-V1 | general formula (I-V1) | 10 | — | — |
| 2-Cy-Cy-V1 | general formula (I-V1) | — | — | — |
| Compound of formula (I-28H) | general formula (I-1) | — | 0.15 | 0.15 |
| Compound of formula (I-32H) | general formula (I-1) | — | — | 0.15 |
| V-Cy-Ph-Ph-3 | general formula (III-H) | 10 | — | — |
| 3-Cy-1O-Ph5-O2 | general formula (II-1A-1) | 8 | — | — |
| 1V-Cy-1O-Ph5-O1 | general formula (II-1A-1) | 4 | — | — |
| 1V-Cy-1O-Ph5-O2 | general formula (II-1A-1) | 4 | — | — |
| 3-Cy-Cy-1O-Ph5-O2 | general formula (II-1B-1) | 9 | — | — |
| V-Cy-Cy-1O-Ph5-O2 | general formula (II-1B-1) | 12 | — | — |
| 1V-Cy-Cy-1O-Ph5-O1 | general formula (II-1B-1) | 5 | — | — |
| 1V-Cy-Cy-1O-Ph5-O2 | general formula (II-1B-1) | 5 | — | — |
| 3-Ph-Ph5-Ph-1 | general formula (LC3-b1) | 5 | — | — |
| 3-Ph-Ph5-Ph-2 | general formula (LC3-b1) | 8 | — | — |
| Composition LC-C | | — | 99.85 | 99.7 |
| Total | | 100 | 100 | 0.3 |
| Tni [° C.] | | 91 | 91 | 91 |
| Δn | | 0.115 | 0.115 | 0.115 |
| η [mPa · s] | | 19.4 | 19.4 | 19.4 |
| γ1 [mPa · s] | | 121 | 121 | 121 |
| Δε | | −4.0 | −4.0 | −4.0 |
| K33 [pN] | | 17.9 | 17.9 | 17.9 |
| γ1/K33 | | 6.8 | 6.8 | 6.8 |
| VHR (UV) | | 51 | 88 | 93 |

LC-9 and LC-10, which are liquid crystal compositions according to the present invention, were found to have low viscosities (η), low rotational viscosities (γ₁), high K₃₃, and significantly higher VHR(UV) than LC-C, which is a comparative example. It was also found that these liquid crystal compositions did not cause uneven display.

Response time measurements on liquid crystal display devices fabricated using these liquid crystal compositions showed that they had sufficiently fast response times for mobile applications. The cell thickness was 3.5 m, and the alignment layers were JALS 2096. The response time was measured at a Von of 5 V, a Voff of 1 V, and a measurement temperature of 25° C. using an Autronic-Melchers DMS 703.

A PSVA liquid crystal display device was also fabricated using a liquid crystal composition containing 99.7% by mass of LC-9 and 0.3% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.7% by mass of LC-9 and 0.3% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.5% by mass of LC-9 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.68% by mass of LC-9, 0.3% by mass of the polymerizable monomer represented by formula (XX-4), and 0.02% by mass of the polymerizable monomer represented by formula (Ia-31). It was found that this liquid crystal display device did not exhibit display defects and had a sufficiently fast response time.

A PSVA liquid crystal display device was also fabricated using a liquid crystal composition containing 99.7% by mass of LC-10 and 0.3% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.7% by mass of LC-10 and 0.3% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.5% by mass of LC-10 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.65% by mass of LC-10, 0.3% by mass of the polymerizable monomer represented by formula (XX-4), and 0.05% by mass of the polymerizable monomer represented by formula (Ia-31). It was found that this liquid crystal display device did not exhibit display defects and had a sufficiently fast response time.

### Comparative Example 4, Comparative Example 5, Example 11, and Example 12

Liquid crystal compositions denoted as LC-D (Comparative Example 4), LC-E (Comparative Example 5), LC-11 (Example 11), and LC-12 (Example 12) were prepared and tested for their physical properties. Table 4 summarizes the components and physical properties of the liquid crystal compositions.

TABLE 4

| | | Comparative | | Comparative | |
|---|---|---|---|---|---|
| | | Example 4 | Example 11 | Example 5 | Example 12 |
| | | LC-D | LC-11 | LC-E | LC-12 |
| V-Cy-Cy-V | general formula (I-V) | 32 | — | 27 | — |
| IV-Cy-Cy-V1 | general formula (I-V1) | — | — | 7 | — |
| Compound of formula | general formula (I-1) | — | 0.3 | — | 0.25 |
| (I-32H) | | | | | |
| 3-Ph-Ph-1 | general formula (III-F) | 11 | — | 9 | — |
| 3-Cy-Cy-Ph-1 | general formula (III-G) | 7 | — | 2 | — |
| V-Cy-Ph-Ph-3 | general formula (III-H) | — | — | 5 | — |
| 3-Cy-1O-Ph5-O2 | general formula (II-1A-1) | 7 | — | 4 | — |
| 1V-Cy-1O-Ph5-O2 | general formula (II-1A-1) | — | — | 4 | — |
| 3-Cy-Cy-1O-Ph5-O2 | general formula (II-1B-1) | 12 | — | 16 | — |
| 1V-Cy-Cy-1O-Ph5-O2 | general formula (II-1B-1) | 9 | — | 9 | — |
| 3-Cy-Ph-Ph5-O3 | general formula (II-2B-2) | 7 | — | 6 | — |
| 3-Cy-Ph-Ph5-O4 | general formula (II-2B-2) | 9 | — | 6 | — |
| 4-Cy-Ph-Ph5-O3 | general formula (II-2B-2) | 6 | — | — | — |
| 3-Ph-Ph5-Ph-1 | general formula (LC3-b1) | — | — | 2 | — |
| 1V2-Ph-Ph5-Ph-2V1 | general formula (LC3-b1) | — | — | 3 | — |
| Composition LC-D | | — | 99.7 | — | — |
| Composition LC-E | | — | — | — | 99.75 |
| Total | | 100 | 100 | 100 | 100 |
| Tni [° C.] | | 75 | 75 | 79 | 79 |
| Δn | | 0.104 | 0.104 | 0.110 | 0.110 |
| η [mPa · s] | | 13.4 | 13.4 | 15.1 | 15.1 |
| γ1 [mPa · s ] | | 90 | 90 | 97 | 97 |
| Δε | | −2.8 | −2.8 | −3.0 | −3.0 |
| K33 [pN] | | 14.5 | 14.5 | 15.4 | 15.4 |
| γ1/K33 | | 6.2 | 6.2 | 6.3 | 6.3 |
| VHR (UV) | | 44 | 91 | 47 | 90 |

LC-11 and LC-12, which are liquid crystal compositions according to the present invention, were found to have low viscosities (η), low rotational viscosities (γ₁), and significantly higher VHR(UV) than LC-D and LC-E, which are comparative examples. It was also found that these liquid crystal compositions did not cause uneven display.

Response time measurements on liquid crystal display devices fabricated using these liquid crystal compositions showed that they had sufficiently fast response times for mobile applications. The cell thickness was 3.5 μm, and the alignment layers were JALS 2096. The response time was measured at a Von of 6 V, a Voff of 1 V, and a measurement temperature of 25° C. using an Autronic-Melchers DMS 703.

A PSVA liquid crystal display device was also fabricated using a liquid crystal composition containing 99.7% by mass of LC-11 and 0.3% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.7% by mass of LC-11 and 0.3% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.5% by mass of LC-11 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-11, 0.3% by mass of the polymerizable monomer represented by formula (XX-4), and 0.1% by mass of the polymerizable monomer represented by formula (Ia-31). It was found that this liquid crystal display device did not exhibit display defects and had a sufficiently fast response time.

A PSVA liquid crystal display device was also fabricated using a liquid crystal composition containing 99.7% by mass of LC-12 and 0.3% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.7% by mass of LC-12 and 0.3% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.5% by mass of LC-12 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-12, 0.3% by mass of the polymerizable monomer represented by formula (XX-4), and 0.1% by mass of the polymerizable monomer represented by formula (Ia-31). It was found that this liquid crystal display device did not exhibit display defects and had a sufficiently fast response time.

### Comparative Example 6, Example 13, Example 14, and Example 15

Liquid crystal compositions denoted as LC-F (Comparative Example 6), LC-13 (Example 13), LC-14 (Example 14), and LC-15 (Example 15) were prepared and tested for their physical properties. Table 5 summarizes the components and physical properties of the liquid crystal compositions.

TABLE 5

| | | Comparative | | | |
|---|---|---|---|---|---|
| | | Example 6 | Example 13 | Example 14 | Example 15 |
| | | LC-F | LC-13 | LC-14 | LC-15 |
| LC-F | | — | 99.93 | 99.94 | 99.93 |
| HALS | (I-a1-1) | — | 0.07 | — | — |
| HALS | (I-28H) | — | — | 0.03 | 0.02 |
| HALS | (I-32H) | — | — | 0.03 | 0.05 |
| 3-Cy-Cy-V1 | (I-V1) | 12 | — | — | — |
| 3-Cy-Cy-2 | (III-A) | 16 | — | — | — |
| 1V-Cy-Cy-1O-Ph5-O2 | (II-1B-1) | 6 | — | — | — |
| 1-Ph-2-Ph-Ph5-O2 | (PAP-1) | 4 | — | — | — |
| 3-Ph-2-Ph-Ph5-O2 | (PAP-1) | 6 | — | — | — |
| 3-Cy-Ph5-O2 | (II-2A-1) | 13 | — | — | — |
| 3-Ph-Ph5-O2 | (II-2A-2) | 13 | — | — | — |
| 2-Cy-Cy-Ph5-O2 | (II-2B-1) | 7 | — | — | — |
| 3-Cy-Cy-Ph5-O2 | (II-2B-1) | 7 | — | — | — |
| 2-Cy-Ph-Ph5-O2 | (II-2B-2) | 8 | — | — | — |
| 3-Cy-Ph-Ph5-O2 | (II-2B-2) | 8 | — | — | — |
| | | 100 | 100 | 100 | 100 |
| T_{NI} [° C.] | | 76 | 75 | 76 | 75 |
| Δn | | 0.114 | 0.114 | 0.114 | 0.114 |
| γ₁ [mPa · s] | | 117 | 116 | 116 | 116 |
| Δε | | −4.4 | −4.4 | −4.4 | −4.4 |
| K33 [pN] | | 15.4 | 15.4 | 15.5 | 15.5 |
| γ1/K33 | | 7.6 | 7.5 | 7.5 | 7.5 |
| VHR (UV) | | 75 | 96 | 95 | 95 |

LC-13, which is a liquid crystal composition according to the present invention, was found to have a low viscosity (η), a low rotational viscosity (γ₁), and a significantly higher VHR(UV) than LC-F, which is a comparative example.

LC-13, which is a liquid crystal composition according to the present invention, left no drop marks during ODF. This liquid crystal display device also did not exhibit uneven alignment. It was also found that this liquid crystal display device did not exhibit image-sticking during operation.

A response time measurement on this liquid crystal display device showed that it had a sufficiently fast response time for mobile applications. The cell thickness was 3.0 μm, and the alignment layers were JALS 2096. The response time was measured at a Von of 5 V, a Voff of 1 V, and a measurement temperature of 25° C. using an Autronic-Melchers DMS 703.

A PSVA liquid crystal display device was also fabricated using a liquid crystal composition containing 99.65% by mass of LC-13 and 0.35% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.6% by mass of LC-13 and 0.4% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.7% by mass of LC-13 and 0.3% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-13, 0.35% by mass of the polymerizable monomer represented by formula (XX-4), and 0.05% by mass of the polymerizable monomer represented by formula (Ia-31). It was found that this liquid crystal display device did not exhibit display defects and had a sufficiently fast response time.

PSVA liquid crystal display devices were also fabricated using liquid crystal compositions containing 99.7% by mass of LC-13 and 0.3% by mass of the polymerizable monomer represented by formula (XX-2) to which 50 ppm of the antioxidant represented by formula (H-11) or (H-14) was added. It was found that these liquid crystal display devices did not exhibit display defects and had sufficiently fast response times.

A PSVA liquid crystal display device was also fabricated using a liquid crystal composition containing 99.5% by mass of LC-13 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-13, 0.1% by mass of the polymerizable monomer represented by formula (XX-1), and 0.3% by mass of the polymerizable monomer represented by formula (M-302). It was found that this liquid crystal display device did not exhibit display defects and had a sufficiently fast response time.

Similar experiments conducted on LC-14 and LC-15 yielded similar results.

### Comparative Example 7, Example 16, Example 17, and Example 18

Liquid crystal compositions denoted as LC-G (Comparative Example 7), LC-16 (Example 16), LC-17 (Example 17), and LC-18 (Example 18) were prepared and tested for their physical properties. Table 6 summarizes the components and physical properties of the liquid crystal compositions.

TABLE 6

| | | Comparative | | | |
|---|---|---|---|---|---|
| | | Example 7 | Example 16 | Example 17 | Example 18 |
| | | LC-G | LC-16 | LC-17 | LC-18 |
| LC-G | | — | 99.92 | 99.92 | 99.92 |
| HALS | (I-a1-1) | — | 0.08 | — | — |
| HALS | (I-a2-1) | — | — | 0.08 | — |
| HALS | (I-a5-1) | — | — | — | 0.08 |
| 3-Cy-Cy-V | (I-V) | 28 | — | — | — |
| 1V-Cy-Cy-1O-Ph5-O2 | (II-1B-1) | 6 | — | — | — |
| 1-Ph-2-Ph-Ph5-O2 | (PAP-1) | 4 | — | — | — |
| 3-Ph-2-Ph-Ph5-O2 | (PAP-1) | 6 | — | — | — |
| 3-Cy-Ph5-O2 | (II-2A-1) | 13 | — | — | — |
| 3-Ph-Ph5-O2 | (II-2A-2) | 13 | — | — | — |
| 2-Cy-Cy-Ph5-O2 | (II-2B-1) | 7 | — | — | — |
| 3-Cy-Cy-Ph5-O2 | (II-2B-1) | 7 | — | — | — |
| 2-Cy-Ph-Ph5-O2 | (II-2B-2) | 8 | — | — | — |
| 3-Cy-Ph-Ph5-O2 | (II-2B-2) | 8 | — | — | — |
| | | 100 | 100 | 100 | 100 |
| T_{NI} [° C.] | | 73 | 73 | 73 | 73 |
| Δn | | 0.112 | 0.112 | 0.112 | 0.112 |
| γ₁ [mPa · s] | | 103 | 104 | 104 | 104 |
| Δε | | −4.4 | −4.4 | −4.4 | −4.4 |
| K³³ [pN] | | 14.7 | 14.6 | 14.7 | 14.8 |
| γ₁/K³³ | | 7.0 | 7.1 | 7.1 | 7.0 |
| VHR (UV) | | 64 | 95 | 94 | 97 |

LC-16, LC-17, and LC-18, which are liquid crystal compositions according to the present invention, were found to have low viscosities (η), low rotational viscosities (γ₁), low γ₁/K₃₃, and significantly higher VHR(UV) than LC-G, which is a comparative example.

LC-16, LC-17, and LC-18, which are liquid crystal compositions according to the present invention, left no drop marks during ODF. These liquid crystal display devices also did not exhibit uneven alignment. It was also found that these liquid crystal display devices did not exhibit image-sticking during operation.

Response time measurements on these liquid crystal display devices showed that they had sufficiently fast response times for mobile applications. The cell thickness was 3.0 μm, and the alignment layers were JALS 2096. The response time was measured at a Von of 5 V, a Voff of 1 V, and a measurement temperature of 25° C. using an Autronic-Melchers DMS 703.

A PSVA liquid crystal display device was also fabricated using a liquid crystal composition containing 99.65% by mass of LC-16 and 0.35% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.6% by mass of LC-17 and 0.4% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.7% by mass of LC-18 and 0.3% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-18, 0.35% by mass of the polymerizable monomer represented by formula (XX-4), and 0.05% by mass of the polymerizable monomer represented by formula (Ia-31). It was found that this liquid crystal display device did not exhibit display defects and had a sufficiently fast response time.

PSVA liquid crystal display devices were also fabricated using liquid crystal compositions containing 99.7% by mass of LC-18 and 0.3% by mass of the polymerizable monomer represented by formula (XX-2) to which 50 ppm of the antioxidant represented by formula (H-11) or (H-14) was added. It was found that these liquid crystal display devices did not exhibit display defects and had sufficiently fast response times.

A PSVA liquid crystal display device was also fabricated using a liquid crystal composition containing 99.5% by mass of LC-18 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-18, 0.1% by mass of the polymerizable monomer represented by formula (XX-1), and 0.3% by mass of the polymerizable monomer represented by formula (M-302). It was found that this liquid crystal display device did not exhibit display defects and had a sufficiently fast response time.

### Comparative Example 8, Example 19, Example 20, and Example 21

Liquid crystal compositions denoted as LC-H (Comparative Example 8), LC-19 (Example 19), LC-20 (Example 20), and LC-21 (Example 21) were prepared and tested for their physical properties. Table 7 summarizes the components and physical properties of the liquid crystal compositions.

TABLE 7

| | | Comparative | | | |
|---|---|---|---|---|---|
| | | Example 8 | Example 19 | Example 20 | Example 21 |
| | | LC-H | LC-19 | LC-20 | LC-21 |
| LC-H | | — | 99.9 | 99.9 | 99.9 |
| HALS | (I-a1-1) | — | 0.05 | 0.03 | 0.05 |
| HALS | (I-a2-1) | — | — | 0.03 | — |
| HALS | (I-a5-1) | — | — | 0.03 | 0.05 |
| HALS | (I-32H) | — | 0.05 | 0.01 | — |
| 3-Cy-Cy-V | (I-V) | 26 | — | — | — |
| 3-Cy-Ph-Ph-2 | (III-H) | 6 | — | — | — |
| V-Cy-Cy-1O-Ph5-O2 | (II-1B-1) | 6 | — | — | — |
| 1-Ph-2-Ph-Ph5-O2 | (PAP-1) | 4 | — | — | — |
| 3-Cy-Ph5-O2 | (II-2A-1) | 7 | — | — | — |
| 3-Ph-Ph5-O2 | (II-2A-2) | 13 | — | — | — |
| 2-Cy-Cy-Ph5-O2 | (II-2B-1) | 10 | — | — | — |
| 3-Cy-Cy-Ph5-O2 | (II-2B-1) | 10 | — | — | — |
| 2-Cy-Ph-Ph5-O2 | (II-2B-2) | 6 | — | — | — |
| 3-Cy-Ph-Ph5-O2 | (II-2B-2) | 6 | — | — | — |
| 3-Ph-Ph5-Ph-2 | (LC3-b1) | 6 | — | — | — |
| | | 100 | 100 | 100 | 100 |
| T_{NI} [° C.] | | 84 | 83 | 83 | 83 |
| Δn | | 0.121 | 0.120 | 0.120 | 0.120 |
| γ₁ [mPa · s] | | 106 | 105 | 105 | 104 |
| Δε | | −3.7 | −3.7 | −3.7 | −3.7 |
| K33 [pN] | | 14.7 | 14.8 | 14.6 | 14.8 |
| γ1/K33 | | 7.2 | 7.1 | 7.2 | 7.0 |
| VHR (UV) | | 75 | 95 | 95 | 95 |

LC-19, LC-20, and LC-21, which are liquid crystal compositions according to the present invention, were found to have low viscosities (η), low rotational viscosities (γ₁), low γ₁/K₃₃, and significantly higher VHR(UV) than LC-H, which is a comparative example.

LC-19, LC-20, and LC-21, which are liquid crystal compositions according to the present invention, left no drop marks during ODF. These liquid crystal display devices also did not exhibit uneven alignment. It was also found that these liquid crystal display devices did not exhibit image-sticking during operation.

Response time measurements on these liquid crystal display devices showed that they had sufficiently fast response times for mobile applications. The cell thickness was 3.0 μm, and the alignment layers were JALS 2096. The response time was measured at a Von of 5.5 V, a Voff of 1 V, and a measurement temperature of 25° C. using an Autronic-Melchers DMS 703.

A PSVA liquid crystal display device was also fabricated using a liquid crystal composition containing 99.65% by mass of LC-21 and 0.35% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.6% by mass of LC-21 and 0.4% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.7% by mass of LC-21 and 0.3% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-21, 0.35% by mass of the polymerizable monomer represented by formula (XX-4), and 0.05% by mass of the polymerizable monomer represented by formula (Ia-31). It was found that this liquid crystal display device did not exhibit display defects and had a sufficiently fast response time.

PSVA liquid crystal display devices were also fabricated using liquid crystal compositions containing 99.7% by mass of LC-21 and 0.3% by mass of the polymerizable monomer represented by formula (XX-2) to which 50 ppm of the antioxidant represented by formula (H-11) or (H-14) was added. It was found that these liquid crystal display devices did not exhibit display defects and had sufficiently fast response times.

A PSVA liquid crystal display device was also fabricated using a liquid crystal composition containing 99.5% by mass of LC-21 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-21, 0.1% by mass of the polymerizable monomer represented by formula (XX-1), and 0.3% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.65% by mass of LC-19 and 0.35% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.7% by mass of LC-19, 0.28% by mass of the polymerizable monomer represented by formula (XX-4), and 0.02% by mass of the polymerizable monomer represented by formula (Ia-31). It was found that this liquid crystal display device did not exhibit display defects and had a sufficiently fast response time.

A PSVA liquid crystal display device was also fabricated using a liquid crystal composition containing 99.7% by mass of LC-19 and 0.3% by mass of the polymerizable monomer represented by formula (XX-2) to which 30 ppm of the antioxidant represented by formula (H-14) was added. It was found that this liquid crystal display device did not exhibit display defects and had a sufficiently fast response time.

### Comparative Example 9, Example 22, Example 23, and Example 24

Liquid crystal compositions denoted as LC-I (Comparative Example 9), LC-22 (Example 22), LC-23 (Example 23), and LC-24 (Example 24) were prepared and tested for their physical properties. Table 8 summarizes the components and physical properties of the liquid crystal compositions.

TABLE 8

| | | Comparative | | | |
|---|---|---|---|---|---|
| | | Example 9 | Example 22 | Example 23 | Example 24 |
| | | LC-I | LC-22 | LC-23 | LC-24 |
| LC-I | | — | 99.92 | 99.92 | 99.94 |
| HALS | (I-a1-1) | — | 0.08 | — | — |
| HALS | (I-a1-6) | — | — | 0.08 | — |
| HALS | (I-28H) | — | — | — | 0.03 |
| HALS | (I-32H) | — | — | — | 0.03 |
| V-Cy-Cy-V | (I-V) | 32 | — | — | — |
| 3-Ph-Ph-1 | (III-F) | 7 | — | — | — |
| 5-Ph-Ph-1 | (III-F) | 4 | — | — | — |
| 3-Cy-Cy-Ph-1 | (III-G) | 7 | — | — | — |
| 3-Cy-1O-Ph5-O2 | (II-1A-1) | 5 | — | — | — |
| 2-Cy-Cy-1O-Ph5-O2 | (II-1B-1) | 12 | — | — | — |
| 3-Cy-Cy-1O-Ph5-O2 | (II-1B-1) | 11 | — | — | — |
| 3-Cy-Ph-Ph5-O3 | (II-2B-2) | 7 | — | — | — |
| 3-Cy-Ph-Ph5-O4 | (II-2B-2) | 9 | — | — | — |
| 4-Cy-Ph-Ph5-O3 | (II-2B-2) | 6 | — | — | — |
| | | 100 | 100 | 100 | 100 |
| T_{NI} [° C.] | | 76 | 75 | 75 | 75 |
| Δn | | 0.101 | 0.101 | 0.101 | 0.101 |
| γ₁ [mPa · s] | | 74 | 73 | 74 | 74 |
| Δε | | −2.8 | −2.8 | −2.8 | −2.8 |
| K33 [pN] | | 13.9 | 14.0 | 14.0 | 13.9 |
| γ1/K33 | | 5.3 | 5.2 | 5.3 | 5.3 |
| VHR (UV) | | 51 | 93 | 95 | 90 |

LC-22, LC-23, and LC-24, which are liquid crystal compositions according to the present invention, were found to have low viscosities (η), low rotational viscosities (γ₁), low γ₁/K₃₃, and significantly higher VHR(UV) than LC-I, which is a comparative example.

LC-22, LC-23, and LC-24, which are liquid crystal compositions according to the present invention, left no drop marks during ODF. These liquid crystal display devices also did not exhibit uneven alignment. It was also found that these liquid crystal display devices did not exhibit image-sticking during operation.

Response time measurements on these liquid crystal display devices showed that they had sufficiently fast response times for mobile applications. The cell thickness was 3.2 μm, and the alignment layers were JALS 2096. The response time was measured at a Von of 6 V, a Voff of 1 V, and a measurement temperature of 25° C. using an Autronic-Melchers DMS 703.

A PSVA liquid crystal display device was also fabricated using a liquid crystal composition containing 99.65% by mass of LC-22 and 0.35% by mass of the polymerizable monomer represented by formula (XX-2). It was found that this liquid crystal display device did not exhibit display defects and had a sufficiently fast response time.

A PSVA liquid crystal display device was also fabricated using a liquid crystal composition containing 99.6% by mass of LC-22 and 0.4% by mass of the polymerizable monomer represented by formula (XX-4). It was found that this liquid crystal display device did not exhibit display defects and had a sufficiently fast response time.

A PSVA liquid crystal display device was also fabricated using a liquid crystal composition containing 99.7% by mass of LC-22 and 0.3% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-23, 0.35% by mass of the polymerizable monomer represented by formula (XX-4), and 0.05% by mass of the polymerizable monomer represented by formula (Ia-31). It was found that this liquid crystal display device did not exhibit display defects and had a sufficiently fast response time.

A PSVA liquid crystal display device was also fabricated using a liquid crystal composition containing 99.7% by mass of LC-23 and 0.3% by mass of the polymerizable monomer represented by formula (XX-2) to which 60 ppm of the antioxidant represented by formula (H-11) was added. It was found that this liquid crystal display device did not exhibit display defects and had a sufficiently fast response time.

A PSVA liquid crystal display device was also fabricated using a liquid crystal composition containing 99.5% by mass of LC-23 and 0.5% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.6% by mass of LC-23 and 0.4% by mass of the polymerizable monomer represented by formula (M-302) to which 65 ppm of the antioxidant represented by formula (H-14) was added. It was found that this liquid crystal display device did not exhibit display defects and had a sufficiently fast response time.

A PSVA liquid crystal display device was also fabricated using a liquid crystal composition containing 99.6% by mass of LC-23, 0.1% by mass of the polymerizable monomer represented by formula (XX-1), and 0.3% by mass of the polymerizable monomer represented by formula (M-302). It was found that this liquid crystal display device did not exhibit display defects and had a sufficiently fast response time.

A PSVA liquid crystal display device was also fabricated using a liquid crystal composition containing 99.75% by mass of LC-24 and 0.25% by mass of the polymerizable monomer represented by formula (M-302). It was found that this liquid crystal display device did not exhibit display defects and had a sufficiently fast response time.

The above results demonstrated that the liquid crystal compositions according to the present invention had sufficiently low viscosities (η), sufficiently low rotational viscosities (γ₁), high elastic constants (K₃₃), high VHR(UV), and large absolute values of negative dielectric anisotropy (Δ∈) without decreased refractive index anisotropy (Δn) or nematic-isotropic liquid phase transition temperature (Tₙᵢ) and that the liquid crystal display devices including these liquid crystal compositions had fast response times and good display quality with reduced or no display defects.

1. A liquid crystal composition comprising:
one or more compounds represented by general formula (I-IV): 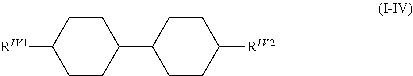
(wherein R^{IV1} and R^{IV2} are each independently an alkyl group of 1 to 10 carbon atoms, an alkoxyl group of 1 to 10 carbon atoms, an alkenyl group of 2 to 10 carbon atoms, or an alkenyloxy group of 2 to 10 carbon atoms, wherein one or more non-adjacent —CH₂— groups present in the groups are each independently optionally replaced with —O— or —S—, and one or more hydrogen atoms present in the groups are each independently optionally replaced with a fluorine or chlorine atom); and
one or more compounds represented by general formula (I): 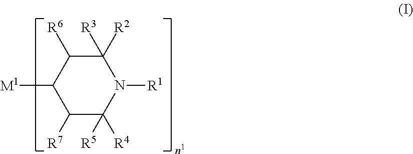
(wherein R¹ is a hydrogen atom, —O—, —OH, or an alkyl group of 1 to 12 carbon atoms, wherein one or more —CH₂— groups present in the alkyl group are each independently optionally replaced with —O—, —S—, —CH═CH—, —C≡C—, —CO—, —CO—O—, —O—CO—, —OCF₂—, or —CF₂O—; R², R³, R⁴, and R⁵ are each independently an alkyl group of 1 to 8 carbon atoms, wherein one or more —CH₂— groups present in the alkyl group are each independently optionally replaced with —O—, —S—, —CH═CH—, —C≡C—, —CO—, —CO—O—, —O—CO—, —OCF₂—, or —CF₂O—, and R² and R³ and/or R⁴ and R⁵ are optionally taken together to form a ring; R⁶ and R⁷ are each independently a hydrogen atom or an alkyl group of 1 to 6 carbon atoms, wherein one or more —CH₂— groups present in the alkyl group are each independently optionally replaced with —O—, —S—, —CH═CH—, —C≡C—, —CO—, —CO—O—, —O—CO—, —OCF₂—, or —CF₂O—; n¹ is an integer of 1 to 6, wherein if n¹ is an integer of 2 to 6, each occurrence of R¹, R², R³, R⁴, R⁵, R⁶, and R⁷ may be the same or different; and M¹ is a monovalent to hexavalent organic group having a valence equal to n¹).

2. The liquid crystal composition according to claim 1, wherein the one or more compounds represented by general formula (I-IV) are selected from compounds represented by general formula (I-IV) wherein R^{IV1} and R^{IV2} are each independently an alkenyl group of 2 to 10 carbon atoms or an alkenyloxy group of 2 to 10 carbon atoms.

3. The liquid crystal composition according to claim 1, wherein the one or more compounds represented by general formula (I) comprise two or more compounds represented by general formula (I).

4. The liquid crystal composition according claim 1, further comprising one or more compounds selected from the group consisting of compounds represented by general formulas (LC3) to (LC5): 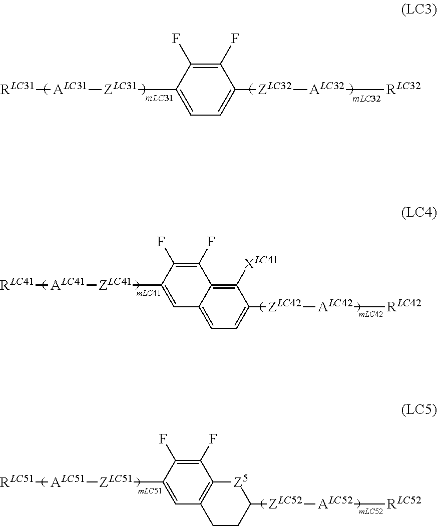
(wherein R^{LC31}, R^{LC32}, R^{LC41}, R^{LC42}, R^{LC51}, and R^{LC52} are each independently an alkyl group of 1 to 15 carbon atoms or an alkenyl group of 2 to 15 carbon atoms, wherein one or more —CH₂— groups or two or more non-adjacent —CH₂— groups in the groups are each independently optionally replaced with —O— or —S—, and one or more hydrogen atoms present in R^{LC31}, R^{LC32}, R^{LC41}, R^{LC42}, R^{LC51}, and R^{LC52} are each independently optionally replaced with a fluorine or chlorine atom; A^{LC31}, A^{LC32}, A^{LC41}, A^{LC42}, A^{LC51}, and A^{LC52} are each independently trans-1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, 2,3-difluoro-1, 4-phenylene, 1,4-cyclohexenylene, tetrahydropyran-2,5-diyl, 1,3-dioxane-2,5-diyl, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl; Z^{LC31}, Z^{LC32}, Z^{LC41}, Z^{LC42}, Z^{LC51}, and Z^{LC52} are each independently a single bond, —CH═CH—, —C≡C—, —CH₂CH₂—, —(CH₂)₄—, —COO—, —OCO—, —OCH₂—, —CH₂O—, —OCF₂—, or —CF₂O—; Z⁵ is —CH₂— or an oxygen atom; X^{LC41} is a hydrogen or fluorine atom; and m^{LC31}, m^{LC32}, m^{LC41}, m^{LC42}, m^{LC51}, and m^{LC52} are each independently 0 to 3, wherein m^{LC31}+m^{LC32}, m^{LC41}+m^{LC42}, and m^{LC51}+m^{LC52} are 1, 2, or 3, and each occurrence of A^{LC31} to A^{LC52} and Z^{LC31} to Z^{LC52} may be the same or different).

5. The liquid crystal composition according to claim 1, further comprising one or more compounds represented by general formula (III): 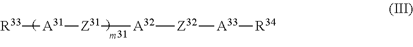
(wherein R³³ and R³⁴ are each independently an alkyl group of 1 to 15 carbon atoms, wherein one or more —CH₂— groups in the alkyl group are optionally replaced with —O—, —CH═CH—, —CO—, —OCO—, —COO—, —C≡C—, —CF₂O—, or —OCF₂—, with the proviso that no oxygen atoms are directly adjacent to each other, and one or more hydrogen atoms in the alkyl group are optionally replaced with halogen; A³¹ to A³³ are each independently trans-1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, 1,4-cyclohexenylene, tetrahydropyran-2,5-diyl, 1,3-dioxane-2,5-diyl, 1,4-bicyclo[2.2.2]octylene, naphthalene-2,6-diyl, decahydronaphthalene-2,6-diyl, or 1,2,3,4-tetrahydronaphthalene-2,6-diyl; Z³¹ and Z³² are each independently a single bond, —CH═CH—, —C≡C—, —CH₂CH₂—, —(CH₂)₄—, —OCH₂—, —CH₂O—, —OCF₂—, or —CF₂O—; and m³¹ is 0, 1, or 2, wherein each occurrence of A³¹ and Z³¹ may be the same or different, with the proviso that compounds represented by general formula (I-IV) are excluded from the compounds represented by general formula (III)).

6. The liquid crystal composition according to claim 1, wherein n¹ in general formula (I) is 3.

7. The liquid crystal composition according to any one of claims 1 to 6, wherein the compounds represented by general formula (I-IV) are present in the liquid crystal composition in a total amount of 3% to 70% by mass.

8. The liquid crystal composition according to claim 1, wherein the compounds represented by general formula (I) are present in the liquid crystal composition in an amount of 0.01% to 5% by mass.

9. The liquid crystal composition according to claim 4, wherein the compounds selected from the group consisting of compounds represented by general formulas (LC3) to (LC5) are present in the liquid crystal composition in a total amount of 10% to 90% by mass.

10. The liquid crystal composition according to claim 1, wherein the liquid crystal composition has a dielectric anisotropy (Δ∈) at 25° C. of −2.0 to −8.0, a refractive index anisotropy (Δn) at 20° C. of 0.08 to 0.14, a viscosity (η) at 20° C. of 10 to 30 mPa·s, a rotational viscosity (γ₁) at 20° C. of 60 to 130 mPa·s, and a nematic-isotropic liquid phase transition temperature (Tₙᵢ) of 60° C. to 120° C.

11. The liquid crystal composition according to claim 1, further comprising one or more polymerizable compounds and/or one or more antioxidants.

12. A liquid crystal display device comprising the liquid crystal composition according to claim 1.

13. An active-matrix liquid crystal display device comprising the liquid crystal composition according to claim 1.

14. A VA, PSVA, PSA, FFS, ECB, or IPS liquid crystal display device comprising the liquid crystal composition according to claim 1.
